(19) United States
(12) Patent Application Publication
(10) Pub. No.: US 2010/0114606 A1
(43) Pub. Date: May 6, 2010

(54) Online therapy database

(76) Inventor: Thomas Snyder, Massapequa Park, NY (US)

Correspondence Address: Thomas A. O'Rourke;Bodner & O'Rourke, LLP, Suite 108, 425 Broadhollow Road, Melville, NY, 11747, US

(21) Appl. No.: 12/291,013

(22) Filed: Nov. 5, 2008

(51) Int. Cl. G06Q 50/00; G06Q 10/00; G06Q 40/00; G06Q 90/00

(52) U.S. Cl. 705/3; 705/9; 705/34; 705/40; 705/2

(57) ABSTRACT

The present invention relates to the field online databases. More specifically, this method allows school districts to save money on hiring therapists on a full time basis. The present invention provides an automated method for providing therapy to a student by first having a school district issue a treatment plan to an agency. Next, an automated system generates a recommended schedule for the student. After the schedule is approved, the therapist meets with the student and records the detailed information from each session. Afterward, the school is billed for the treatment plan and the therapist is compensated for the services rendered.

### FIELD OF THE INVENTION

The present invention relates generally to the field of therapist billing and the like, and more specifically to therapist billing when services are provided to schools in response to a mandate from a governmental authority for the services to be provided. The system enables the school to match student needs with therapist hours and it allows for the therapists to easily bill for the services provided.

### BACKGROUND

Many children require special educational services including academic assistance as well as speech, physical or occupational therapy. Each student's special needs are different and each student needs to receive different services. In order-to do this a student with special needs is provided with an Individualized Education Program (IEP). This program is compiled to meet his/her individual special needs. To implement this program schools must hire therapists and counselors with different areas of knowledge. Therefore school will not keep numerous therapists on staff and will hire them on a contractual basis. This can lead to a complex task of keeping track of hours of service provided, and whether those services are in compliance with a student's mandates. The present invention eases the billing, scheduling and documentation processes for a school district.

An Individualized Education Program, commonly referred to as an IEP is a mandated requirement of the Individuals with Disabilities Education Act (IDEA). An IEP is required for any pupil in the public schools who is found to meet the federal or state requirements for special education and related services.

An IEP typically outlines the following items for each student, Current Performance Level, Accommodations necessary in class, subject areas impacted by the student's disability, goals and objectives to be achieved during the course of the IEP (1 year or less), any Standardized testing accommodations, transportation service, schedule modifications, Parental or guardian concerns, team's vision statement The IEP will also include other pertinent information found necessary by the team, such as a health plan or a behavior plan for some students

An IEP is the written description of an appropriate instructional program for a student with special needs. The use of an IEP in the classroom is made up of several steps to be followed, these are: referral, evaluation, eligibility, development of an IEP, implementation of an IEP, and an annual review.

The first step in creating an IEP is referral. In the step of referral the student is officially referred for special education services, this can only happen if all parties agree that the child exhibits behaviors or disabilities that may inhibit his or her learning experience. Only those with academic performance extensively behind that of their classmates and/or those who express learning, emotional, and behavioral difficulties can be officially referred.

An IEP is created by the IEP team, which can include the student's parents, special education teacher, one general education teacher, student's counselor and school psychologist. The IEP team may also include a school counselor, school administrators, school nurse, and advocates brought in by the school district or parent. Other school personnel necessary to provide service to the student are also a part of the IEP team. This may include a speech therapist, physical therapist, occupational therapist, and all other service providers. Students may also join the IEP team if they have the mental capacity to understand the process.

After the student is referred for special education services, the step of evaluation takes place. Evaluation helps determine many factors, including: whether a child has a disability, whether special education is required and consequently if the child does have a disability, what types of special or related services are needed. The evaluation the student is subjected to should measure different aspects using a variety of measurement methods to determine if the student has any emotional, learning or any other type of disability that impedes him or her from performing as well, or to the capacity of most of their peers, the IEP team should not, under any circumstances make decisions based solely on a single method of evaluation. Furthermore, evaluation should also take place in the native language of the student.

Once the results for the evaluations are ready the step of eligibility takes place. It is during the step of eligibility that the IEP team examines the results from the evaluations and decides as a whole whether the child needs special education.

Following eligibility, the next step in the process of an IEP is the development of an IEP. The IEP team, using the assessment results decides on appropriate education, services and placement. A matrix is then drafted containing the student's present level of performance, indicators about ways the student's disability influences participation and progress in the general curriculum, a statement of measurable goals; including benchmarks or short-terms objectives, the specific educational services to be provided; including program modifications or supports. There is also an explanation of the extent that the child will not participate in general education, a description of all modifications in statewide or district-wide assessments. The matrix also includes the date that services are expected to start as well as the duration of the services.

Subsequently, the general education teacher proceeds to implement all educational services, program modifications or supports as indicated by the individual education plan in the step of implementation of the IEP.

Once the IEP has been implemented an annual review takes place. The IEP team is responsible for conducting an annual review to ensure that the student is meeting goals and making progress. The annual review is to take place on a yearly basis. However, if the present IEP is not effectively helping the student in the classroom, an immediate revision is to occur. This is something all teachers should have in mind because of the consequences that not doing this would have, not only from a legal point of view, but also because if an immediate revision of the IEP is not requested the child will struggle through the rest of the year.

An IEP must be accepted and signed by a parent or guardian before any of the outlined services may begin. The IEP maybe amended; any member of the team may call a meeting at any time to edit the IEP. Many things may be added or subtracted and the parent must again accept and sign any amendments in order for them to take effect.

To implement a student's IEP schools must hire therapists and counselors with different areas of knowledge. Therefore school will not keep numerous therapists on staff and will hire them on a contractual basis. This can lead to a complex task of keeping track of hours of service provided, and whether those services are in compliance with a student's mandate.

### SUMMARY OF THE INVENTION

This present invention relates to the field of therapist billing, therapist scheduling, therapist reporting, and the like, and more specifically to Pediatric Therapists when school-based therapy services are provided to Districts in response to a Mandate from a governmental authority for the services to be provided.

This is preferably a web-based database program that enables a user to match student needs with therapist hours and it allows for the therapists to easily bill for the services provided, scheduling without conflicts, and maintain records and reports for as long a period of time as the law requires.

The present invention solves the current problems faced by schools. The present invention provides a system that eases the administrative burden on a school by efficiently tracking the billing process for a school district. In the beginning of the process, the school first identifies a student who requires therapy. Next the school with the help of the parents and pertinent third parties determines therapy treatment that satisfies the student's needs and issues the determination in the form of a mandate. Next, the school submits the mandate to the government for approval. Generally, the school gets paid in a lump sum for each mandate by the government. To avoid hiring a therapist, the schools hire an agency for each mandate and having the agency handle the administrative aspects of the IEP. Once an agency receives a mandate for a student, the agency assigns a therapist to a student based on the student's needs for the day as detailed in the student's mandate. The agency then, coordinates with the therapist and student to create a schedule. The school makes the child available at the scheduled times. If a child fails to show up, the agency may either cancel the therapist or pay the therapist a no-show fee. The school is generally not reimbursed for this missed session because of the administrative costs incurred by the agency and the inconvenience experienced by the therapist. If the child does show up, the therapist provides the services. After the therapist has provided the services, the therapist supplies the agency with a time sheet indicated the amount of time spent with each client. The agency then confirms that the therapist provided the amount of time required by the mandate and that the mandate has been fulfilled for a given period of time.

The present invention is a database system for use by therapists and school districts. The present invention performs general administrative tasks such as managing a group of therapists for a school, tracking student mandates, therapist visits, and generating financial reports to correctly pay the therapists for work performed and correctly bill the school districts. The present invention comprises an accounting system and a scheduling system for an agency and a session note keeping tool for a therapist.

Once a student is identified as needing special educational needs by the Committee on Special Education (CSE) an Individual Educational Program (IEP) is created for the student. Applicant's system allows the school to request the scheduling of sessions based on the student's IEP mandate. The agency then schedules sessions for the student. Once a therapist has worked with the student they can then input their billing time into the system. The system then bills the school and pays the therapists after receiving approval from the agency.

The present invention is primarily for agencies that provide therapists for public schools, with the intent of saving all parties involved time and money. The present invention is intended to better service children in need a special services in both public and private schools. It includes an accounting system for an agency, as well as a billing tool that expedites the process of gathering district, school, therapist and student information. It stores mandates so that children can be properly treated for any special service they need. These services include, but are not limited to occupational, physical and speech therapy.

The IEP Mandate entered into the system is a key association between the independently functioning systems in the present invention for Medical Billing, Patient Scheduling, and Clinical “Documentation”, or simply Reporting. The Service Mandate is comprised of five basic units: Service type; Ratio; Frequency; Period; and Duration. The program assigns numerical values for each Mandate unit and then assigns a “Mandate Number” to refer to each unit collectively. This unique association is utilized by the system to associate multiple mandates for the same student while handling them separately for 1) Mandate compliance, 2) Accounting purposes, and 3) Record keeping.
1. Mandate compliance purposes refers to whether or not the agency has found “coverage” which is defined as identifying a therapist who is responsible for servicing the mandate. The system utilizes the invention's Scheduling function to compare a student's mandated “Frequency” and “Period” with the therapist's actual schedule to determine a percentage value for mandated sessions scheduled. The therapist is then prompted to schedule each Frequency in a Period. The results are presented in two reports: Scheduled Mandates and Unscheduled Mandates.
2. Accounting Purposes refers to whether or not the agency has received billing codes indicating that a service was performed by the therapist for the scheduled session. The system utilizes the invention's Billing function to superimpose a therapist's schedule over their Billing Sheet and then uses the Mandate “Ratio” and “Duration” to determine a percentage value for mandated sessions billed. If a therapist misses a session and neglects to indicate the reason through billing codes, the system will automatically insert a “Therapist Unavailable” billing code into the billing sheet for that missed session. The results are presented in two reports: Billed Mandates and Unbilled Mandates.
3. Record keeping refers to whether or not the agency has received all required documentation for each student from the Assigned therapist. The system utilizes the invention's Reporting function to compare a student's mandated “Service Type” with the therapist's submitted clinical reports (because multiple Mandates may share a common Service Type they are all addressed in a single report for that service type) to determine a percentage value for reports completed.
4. The percentages for SCHEDULED sessions, BILLED services, and REPORTS completed are combined to determine a Therapist's Overall Ranking; which is displayed on the Therapist Summary Homepage. The Summary is available for DISTRICTS, SCHOOLS, TEACHERS, and STUDENTS located on the “SUMMARY” LINK.

### BRIEF DESCRIPTION OF THE DRAWINGS

FIG. 1 a flow chart which shows the business model of applicant's invention

FIG. 2 is a flowchart which shows how each party can login.

FIG. 3 is a flow chart which shows which billing files are available to each party when they login.

FIG. 4 is a flow chart showing the files required for applicant's system.

FIG. 5 shows the relations between the individual data files.

FIG. 6 shows the therapist input screen.

FIG. 7 shows a list all of the school districts that are register with the administrator.

FIG. 8 lists the schools registered with the administrator of a particular school district.

FIG. 9 is a sample screen shot listing the students receiving services of a particular school.

FIG. 10 shows detailed information about a particular student.

FIG. 11 the input screen where therapists can input hours to be billed.

FIGS. 12A and B are a flow chart showing different features of the program.

FIG. 13 is a flow chart showing the billing system specifically describing the relationship of the system with accounts payable and accounts receivable.

FIG. 14 is a sample of the Therapist Billing Homepage.

FIG. 15 a sample of the Add/Edit Therapist page.

FIG. 16 is a sample of the Add/Edit District page: Part 1

FIG. 17 is a sample of the Add/Edit District page: Part 2

FIG. 18 a sample of the District Scheduling Homepage.

FIG. 19 is a sample of the Add/Edit School page.

FIG. 20 is a sample of the Scheduling School Homepage.

FIG. 21 is a sample of the Add/Edit Teacher page.

FIG. 22 is a sample of the Scheduling Teacher Homepage.

FIG. 23 is a sample of the Add/Edit Student page.

FIG. 24 is a sample of the Student Scheduling Homepage.

FIG. 25 a sample of the Makeup List report that is run from the reports menu and identifies students needing more sessions, based on the mandate so that children needing to get additional treatments can get them.

FIG. 26 a sample of what the Daily Notes entry screen can look like.

FIG. 27 a sample of what the scheduling screen can look like: (List format in edit mode)

FIG. 28 is a sample of what the scheduling screen can look like in calendar mode.

FIG. 29 is an example of billing sheet top of page Part 1.

FIG. 30 is an example of billing sheet—bottom of page Part 2.

FIG. 31 is a sample of what the Payables Report can look like. The Payables (for therapists) shows you who is owed how much. This screen allows you to enter check amounts, and keep track of which therapist is owed how much, what date they were paid and with which check number, and for what amount.

### DETAILED DESCRIPTION

The present invention comprises an accounting system and a scheduling system for an agency and a session note keeping tool for a therapist. The accounting system handles many of the administrative actions related to billing and receiving funds. First, the agency enters the information for the districts and schools they service. Then, the agency enters all sub-contracted therapist information, all student information and all the mandate information for each student into the system. Next, the agency assigns therapists to each individual mandate for the purposes of collecting treatment and billing information. Then, the therapist enters all of their treatment information into the system. Lastly, the system generates accounting reports for the agency so that the agency may bill the school district and pay the therapists. In another embodiment of the invention, the school may be able to make payments to the administrator for services provided by therapists online.

The note keeping tool allows therapists to store important information about each student mandate into the system. The system stores information such as daily student notes, quarterly reports, evaluation notes, evaluation recommendations and annual reviews. The student daily notes include subjective, objective, assessment, plan and billing information. The quarterly reports include objectives addressed, activities performed and responses to treatment and plans. Evaluation notes include general information about the student, clinical observations, orthopedic and neuromuscular status, equilibrium and protective reactions, sense of body positions, propioception, and standardized testing. Evaluation recommendations include recommendations by the therapists regarding what services should be performed. The annual review includes information regarding clinical observations, behavior, neuromuscular status, muscle tone, range of motion, muscle strength, equilibrium and protective reactions, sense of body position, functional abilities, and summary notes.

The program also has a message board, with the ability to send messages as public, in house, or private viewing only, where a user can get updated information or provide such information. The therapist can log in where the therapist can do evaluations and screenings. The therapist can keep track of billed hours and the program can maintain an absence report, as well as other information. The program also has a general ledger portion of the program to assist with billing.

In an alternate embodiment, the therapist will also be able to add information about what services are provided to the student and the progress being made. Therapist could enter notes as to any suggestions for altering the IEP or any difficulties the student is having. In another embodiment the student's parent and teach may also have a login so that they may view the student's progress and communicate with the therapist regarding any suggestions made. This would ensure that services being provided are effective in aiding the student.

The scheduling system allows the agency to schedule sessions for each student and assign therapists to each appointment. The program prevents the agency from over-scheduling therapists or students or overcharging schools for sessions beyond what is allowed by each student's mandate. The information is available online for easy access by the student, parent, therapist or school so that any scheduling problems may be identified and corrected. This leads to a decrease in the number of unattended sessions by a student, thus maximizing the funds spent on a student's mandate.

In one embodiment, the scheduling system may also be programmed to recommend certain therapists for each session. The recommendation engine uses extrinsic information such as therapist location, experience, and availability along with the student's specific therapist needs and student's availability to generate a recommended schedule for the student and therapist. The recommendation engine also resolves conflicts such as when a student or therapist has multiple sessions schedule for similar times, and recommends alternative schedules that work for both parties. The recommendation engine may also use a preferred therapist list provided by each school to give the schools more control over which therapists are scheduled. In addition, the scheduling system may provide appointment notification reminders in the form of a text message sent to the student's and therapist's mobile device, or an email alert message sent to student's or therapist's email address to alert the participants and decrease the number of unattended sessions.

In another embodiment, the system may provide a list of therapists so that school districts may connect to the system online via the internet and the school chooses which therapists the school would prefer to provide services to the student. Another feature provided by the scheduling system is an appointment cancellation tool. If for some reason the student cannot attend the appointment, the student or therapist may connect to the system via the internet and request a cancellation. The scheduling system may either reschedule the appointment or assign another therapist to the appointment so that the session is not unattended.

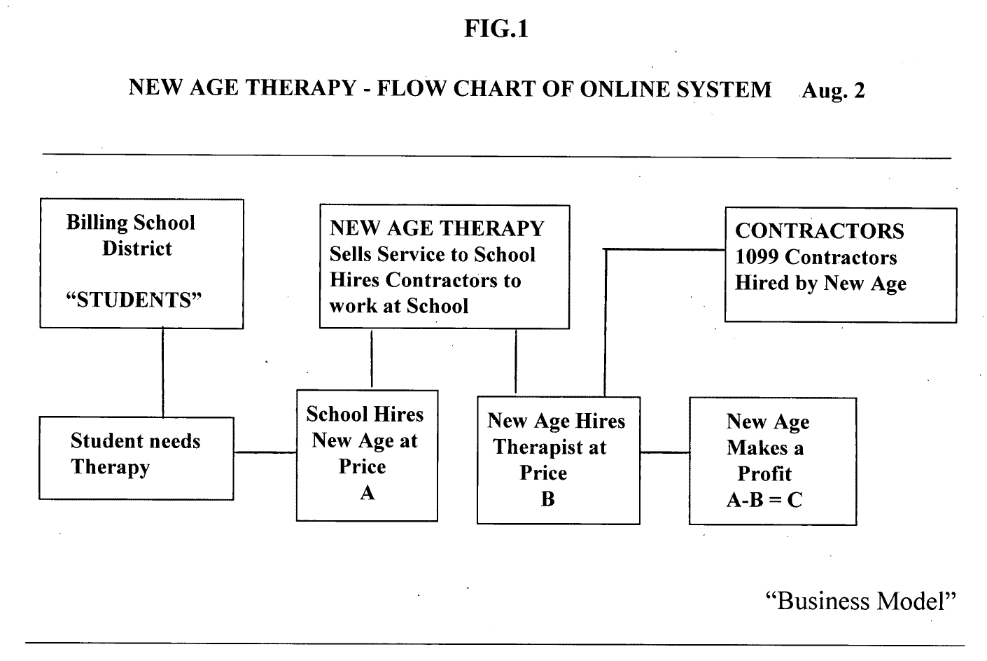

FIG. 1 shows the business model which would be implemented by Applicant's system. Once a student is identified as needing therapy the school district hires an administrator to provide needed therapists. The administrator then hires therapists. The school pays the administrator for its services, the administrator then pays the therapists for their services and the remaining funds are profit for the administrators.

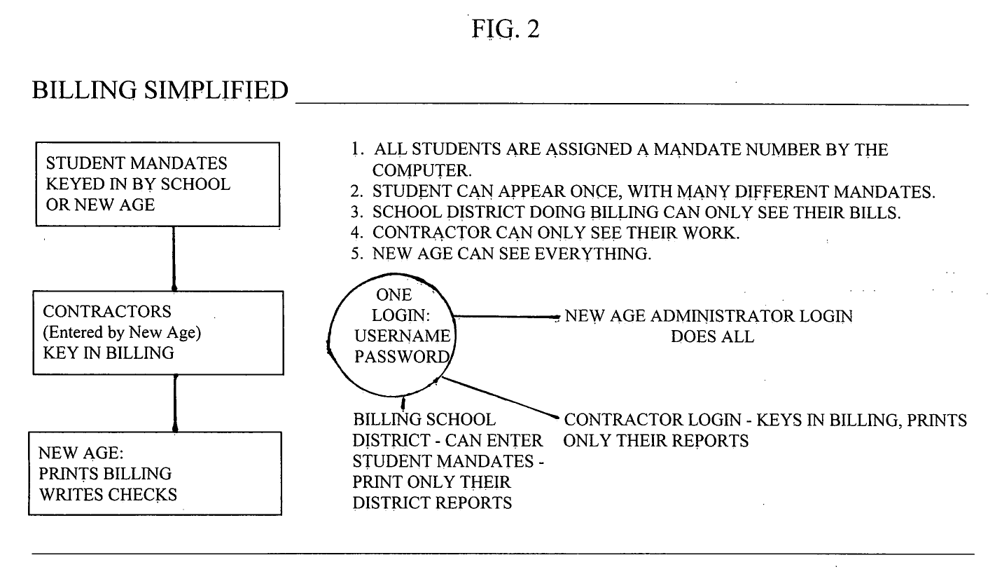

FIG. 2 shows the systems login. The system allows each party to only access that information which is they are permitted to view. The school District is only able to enter student mandates and print district reports. Therapists can enter billing information and print only their reports. The administrator can view all of the information on the system.

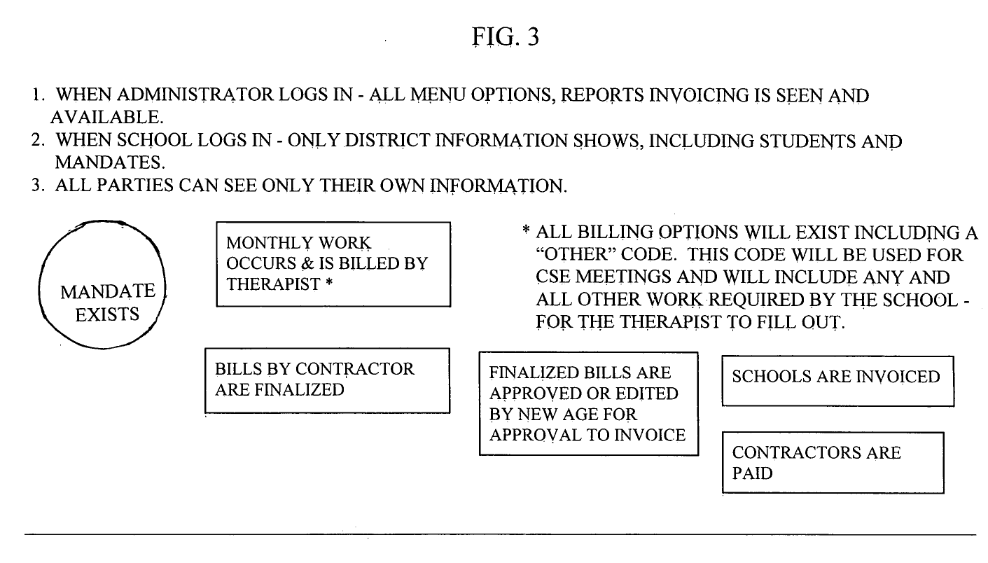

FIG. 3 explains what occurs after login by the administrator and then by a school or contractor. Each party is entitled to view only information that it should have access to or is permitted to view.

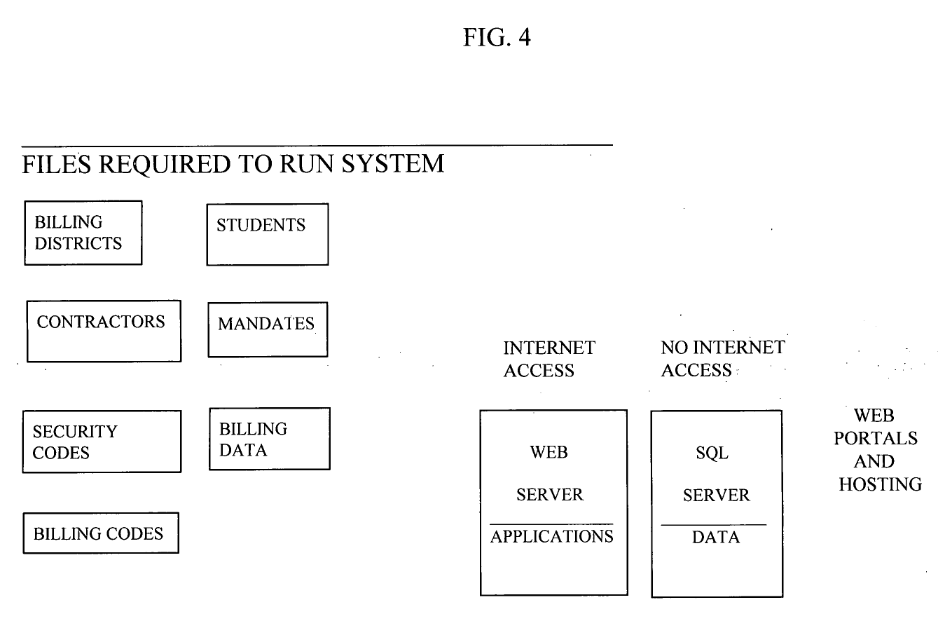

FIG. 4 shows a number of the components of applicant's database system. The database stores district names, contractors, security codes, billing codes, billing data and student IEP mandates each in separate files. These files have are relationally connected to match the information. For example the file with the students is connected to the file with the mandates so that each student's name, and given IEP mandates are matched via the system assigned mandate numbers. The system can run via an internet connection allowing any party to access their information from any location using their login and password. In an alternate embodiment the user may access the system via a closed server which only networks the parties involved in the system.

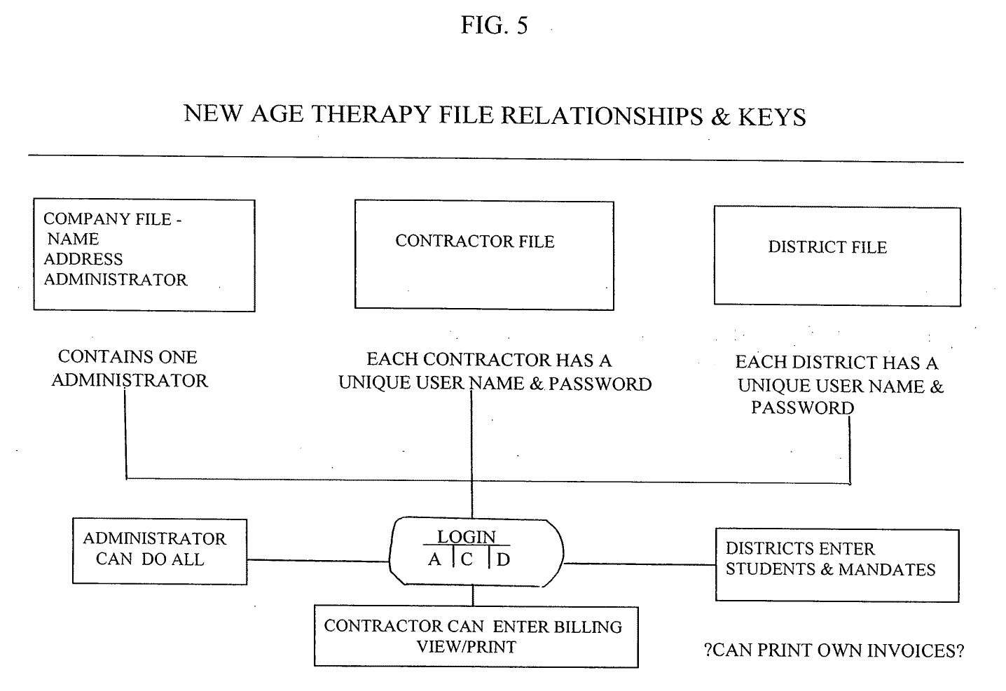

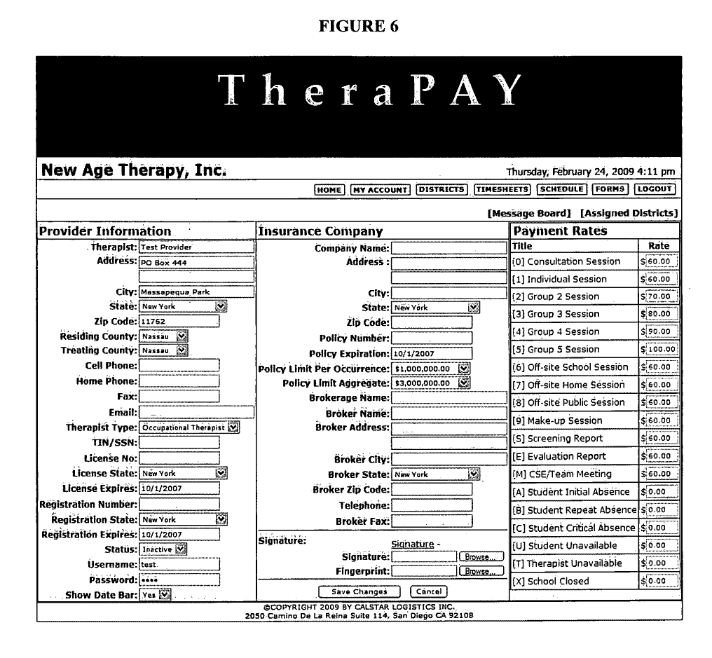

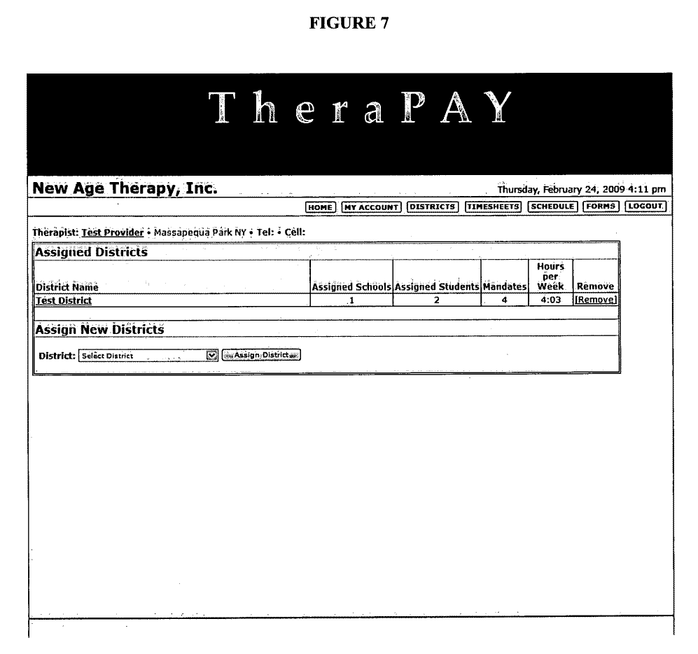

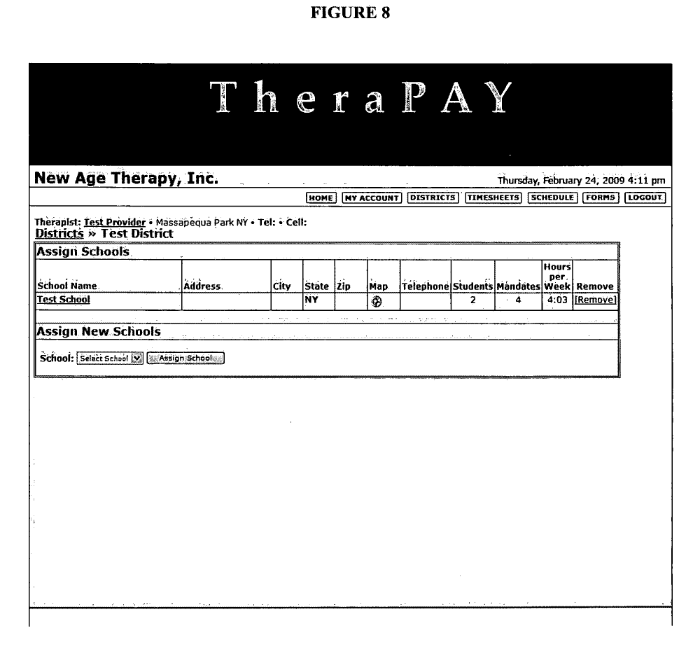

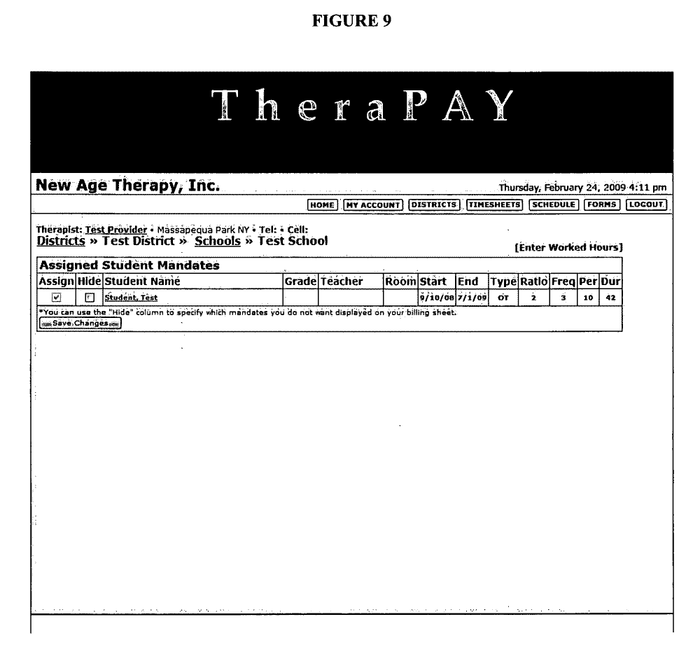

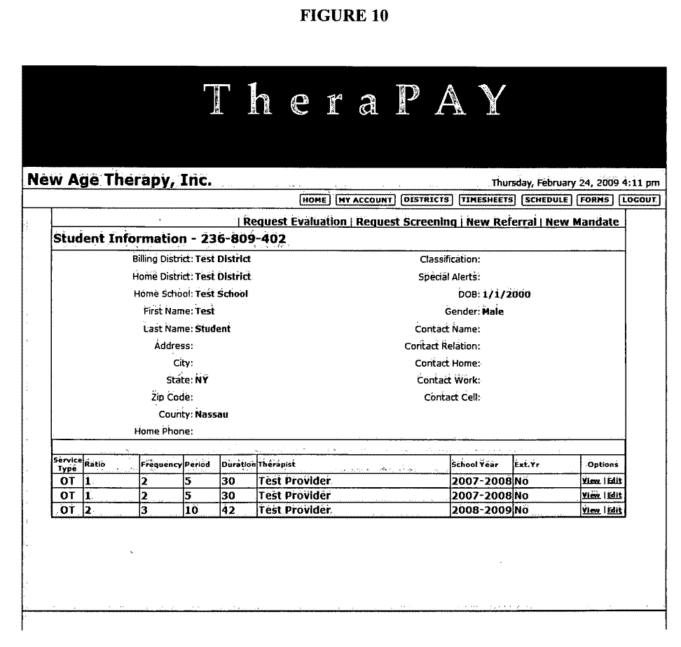

FIG. 5 shows the relationships between the files on the system. Preferably, there are files for the company, the contractor and the school district. The figure also shows limitations on access to information and actions. For example, the administrator of the program can do everything. The contractor can perform certain functions, such as billing. The districts can enter student information and mandates information. If desired, the school district can print invoices. FIG. 6 shows a sample input screen. This is a model print screen merely for demonstrative purposes. This is where therapists can input their information, and view their billing rates. FIG. 7 is a sample screen shot which lists all of the school districts that are register with the administrator. FIG. 8 is sample a screen shot which lists the schools registered with the administrator of a particular school district. This also shows the number of hours therapists have billed per a week as well as the number of students receiving services. FIG. 9 is a sample screen shot listing the students receiving services of a particular school along with the duration of the services and the type of services provided. This screen may also show the student's teacher and grade. FIG. 10 shows detailed information about a particular student as well as the student's mandates.

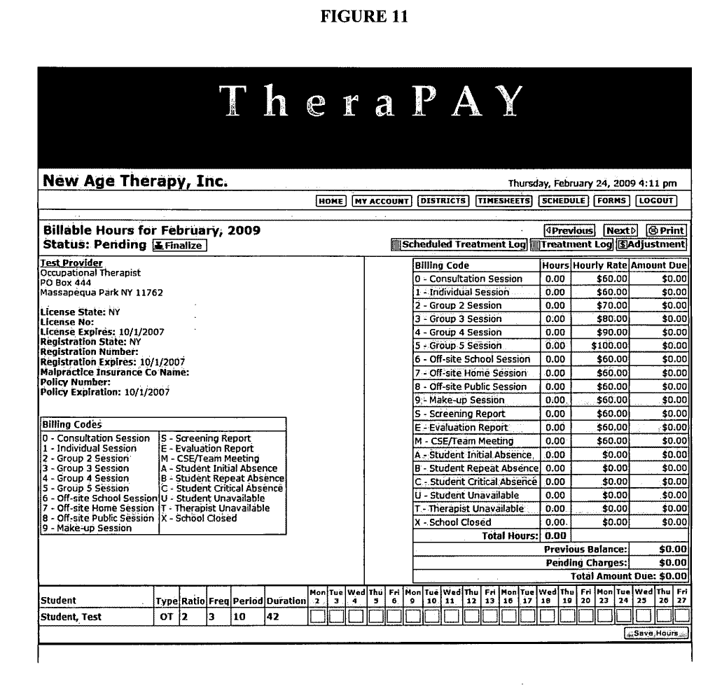

FIG. 11 shows the input screen where therapists can input hours to be billed. Each type of service has a billing code, which corresponds with hourly rates are displayed. Some information about the therapist is also displayed.

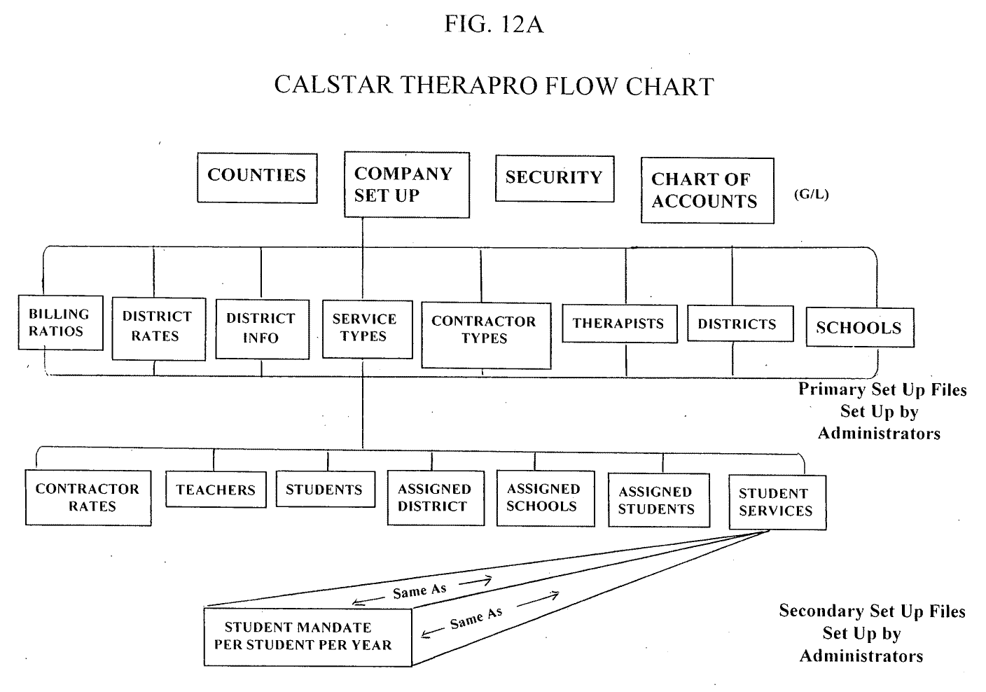

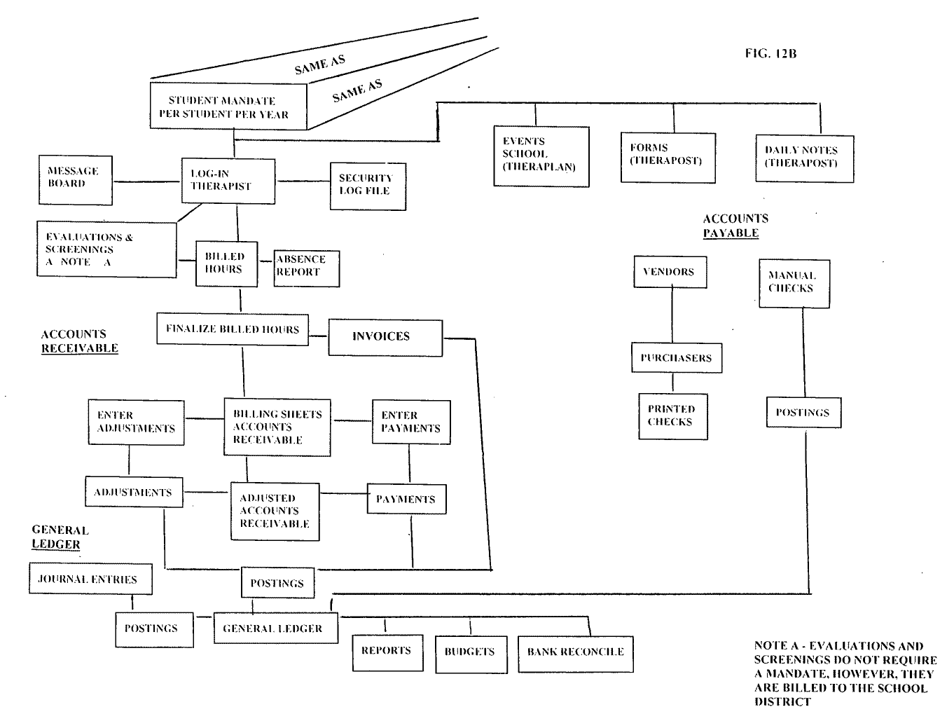

FIGS. 12A and B shows a flow chart for the present invention. There may be an input of information including, but not limited to, such information as counties, company setup, security, and chart of accounts. Other inputs can include billing ratios, district rates, specific district information, service information, contractor information, the identification of therapists, districts and schools. The information can further include contractor rates, teacher information, student information, as well as information on assigned districts, the assigned schools and assigned students. The student services constitutes the “mandate” for each student. This mandate is the program of therapy that is to be provided to the individual student.

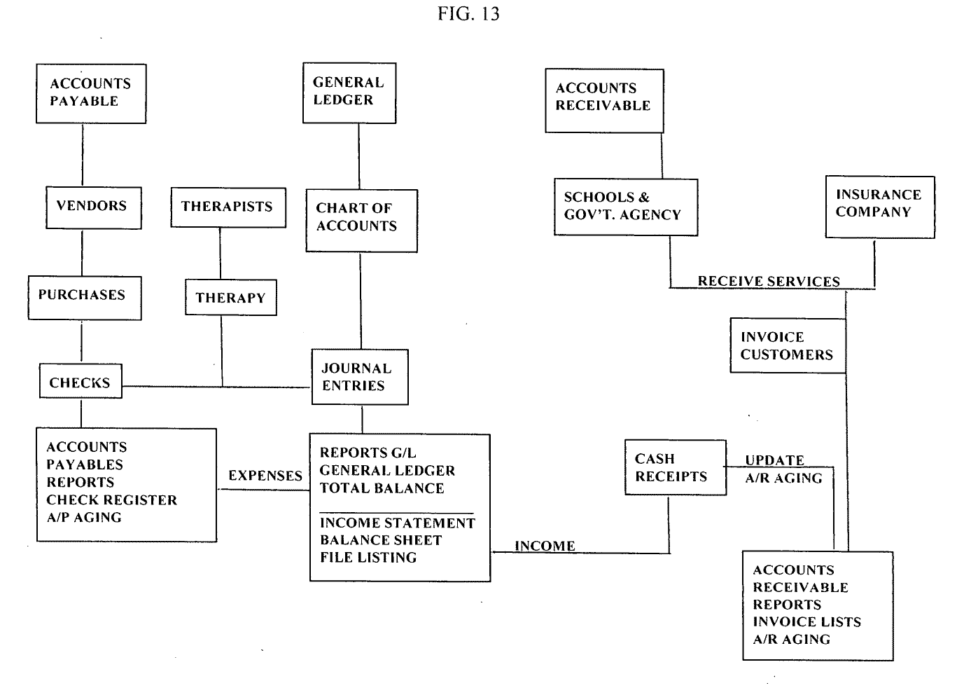

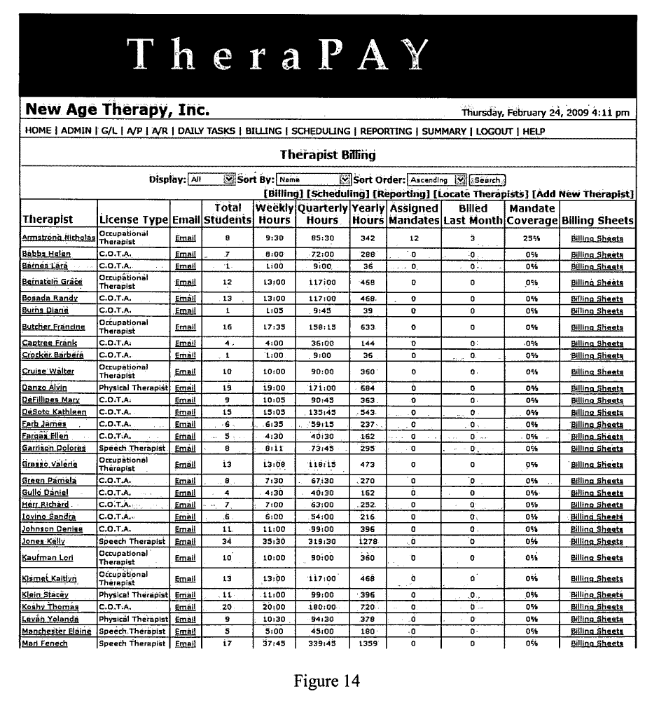

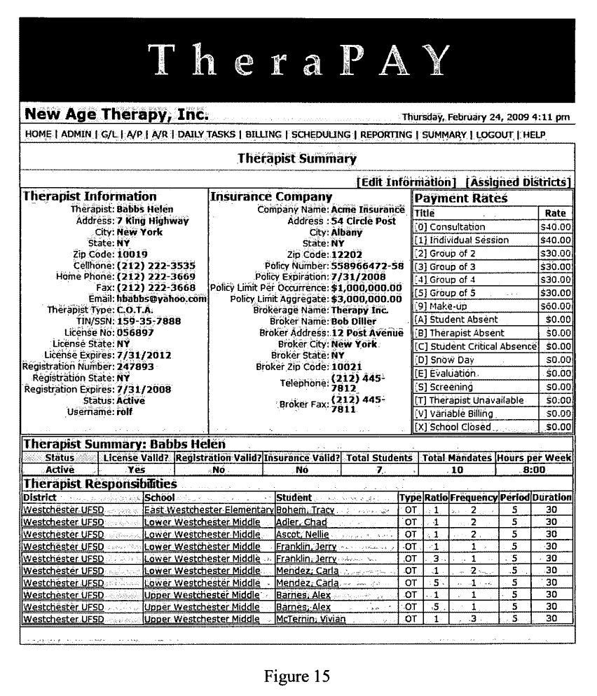

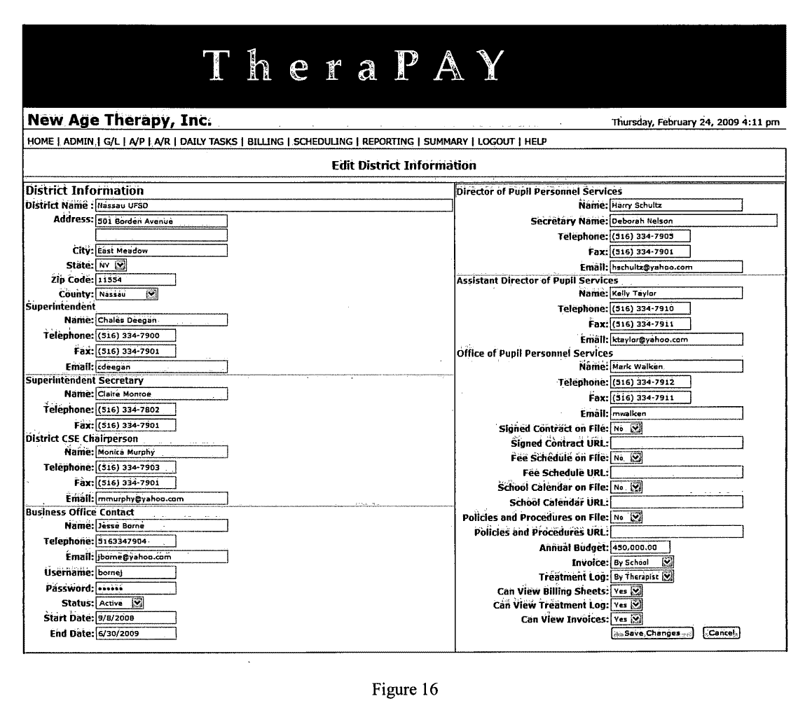

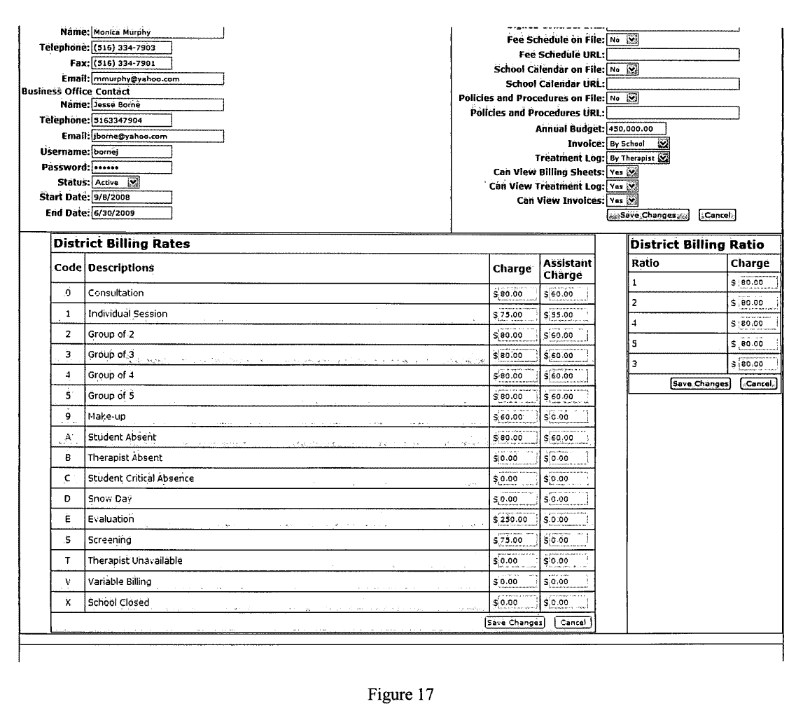

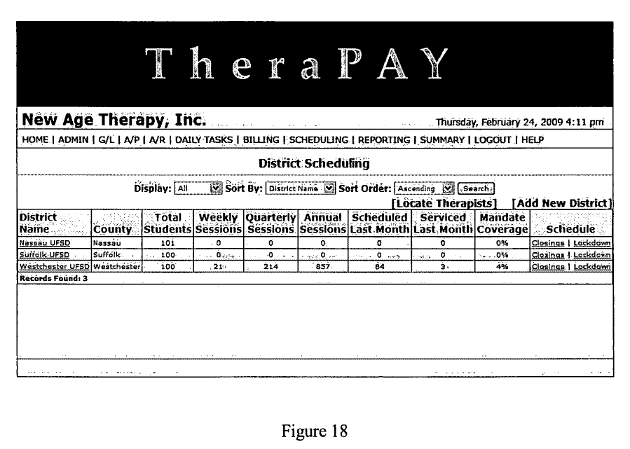

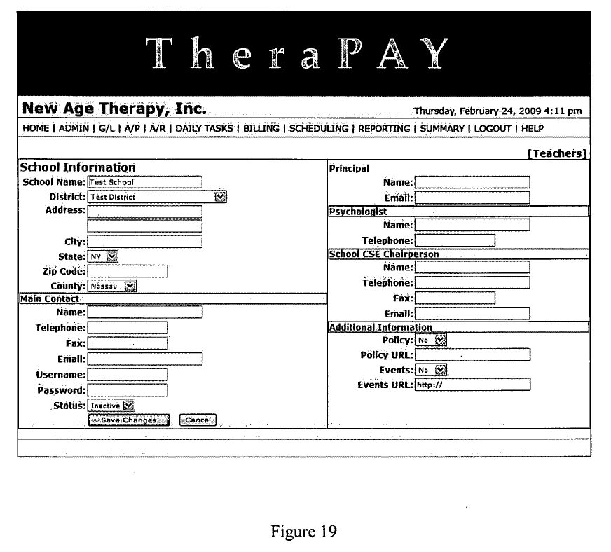

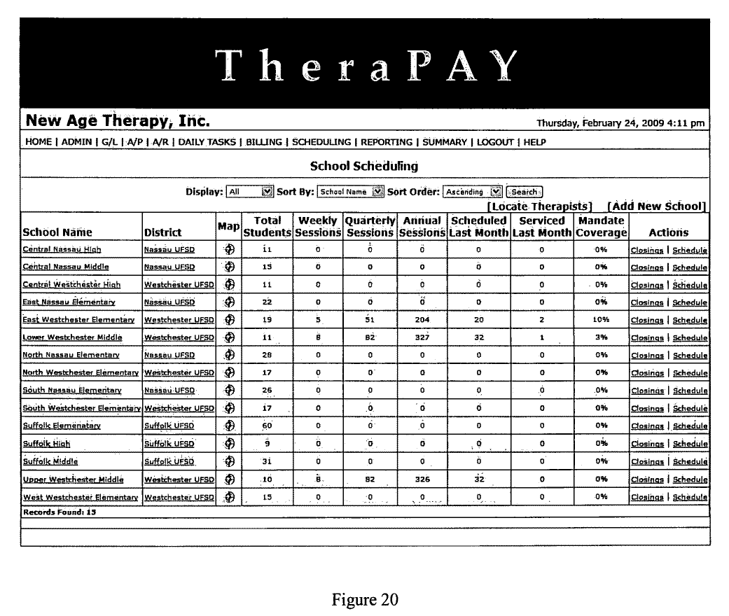

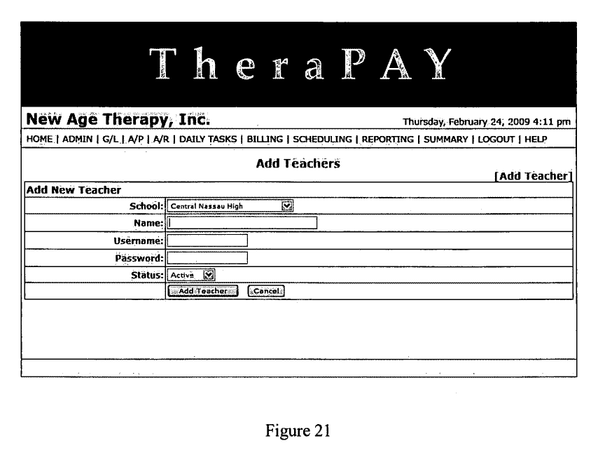

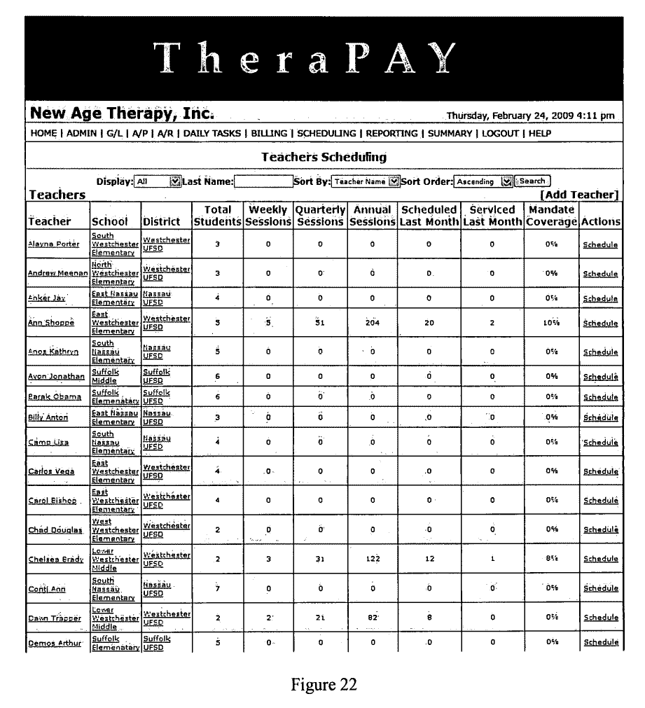

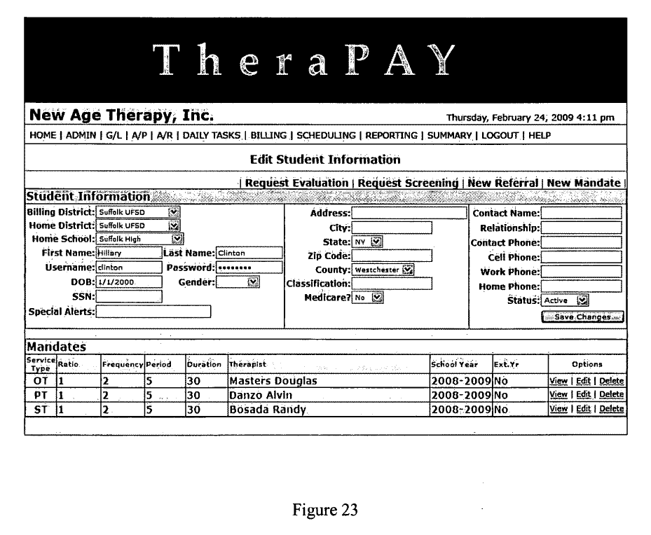

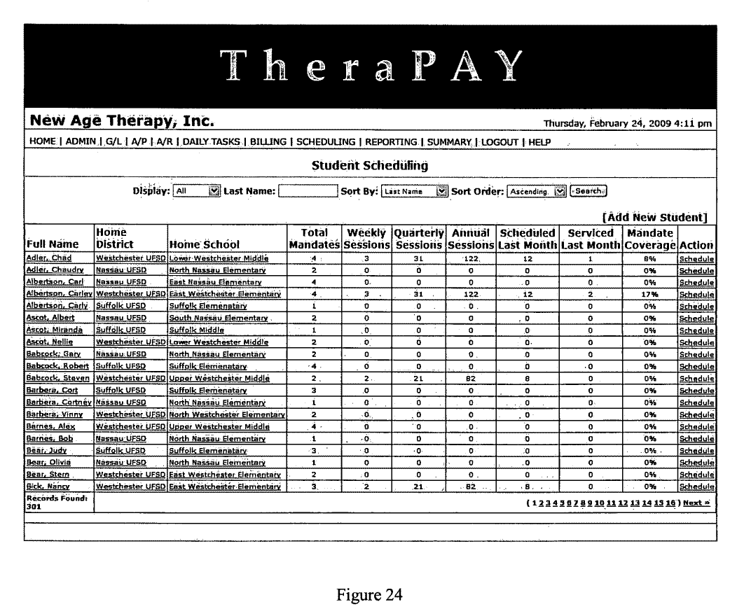

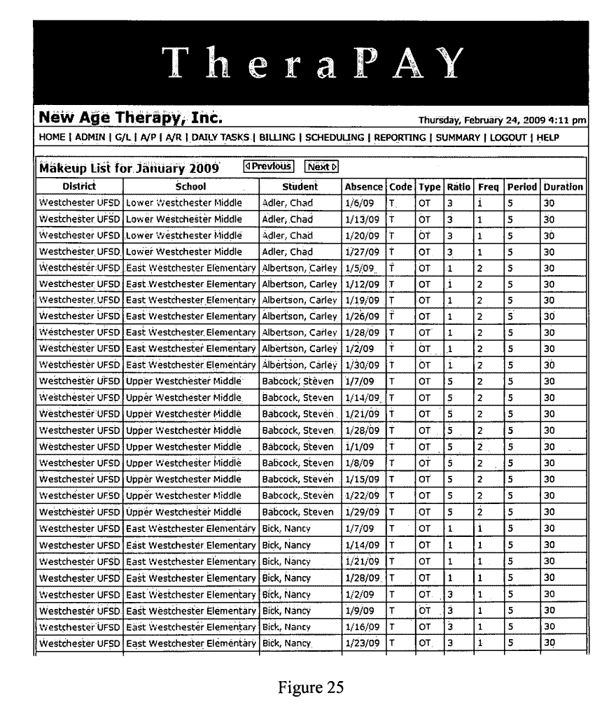

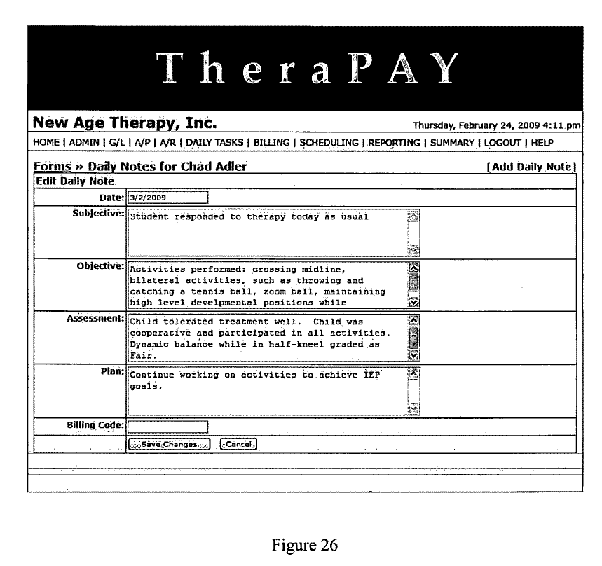

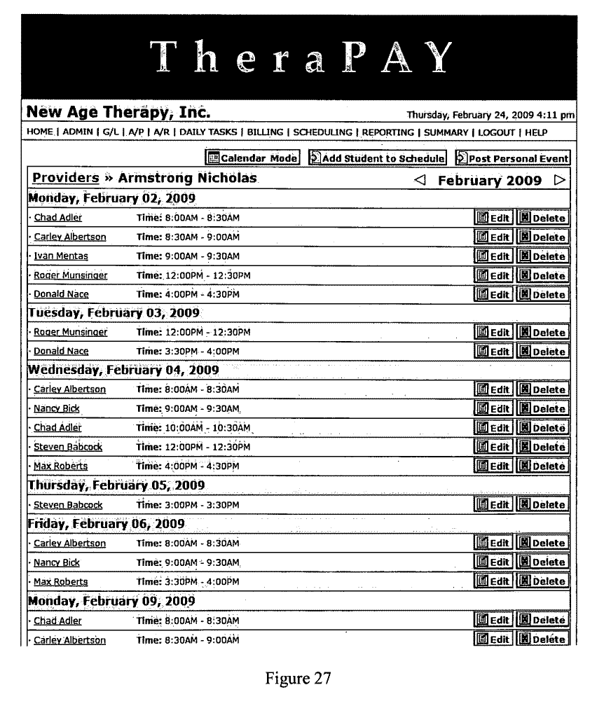

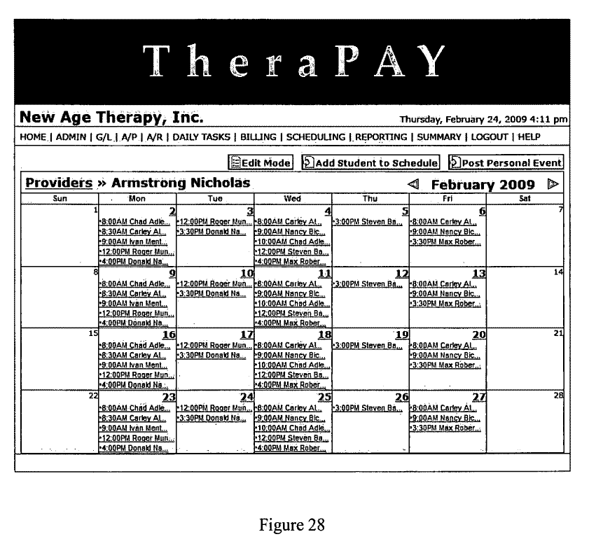

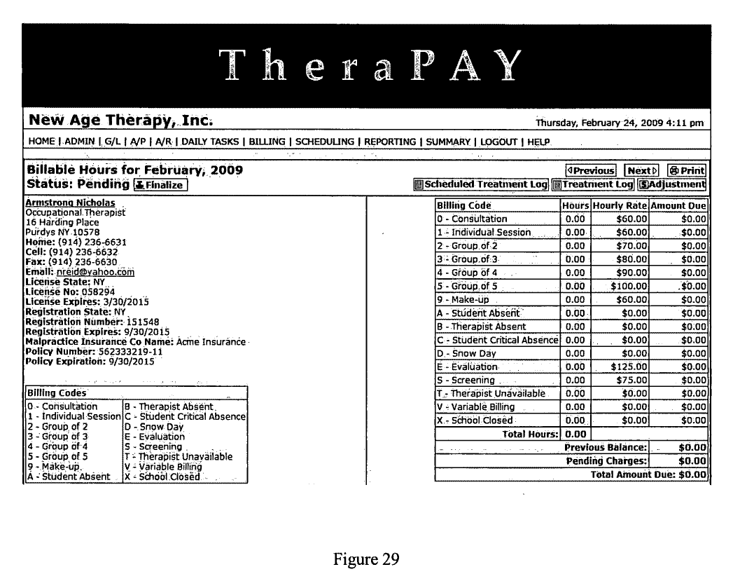

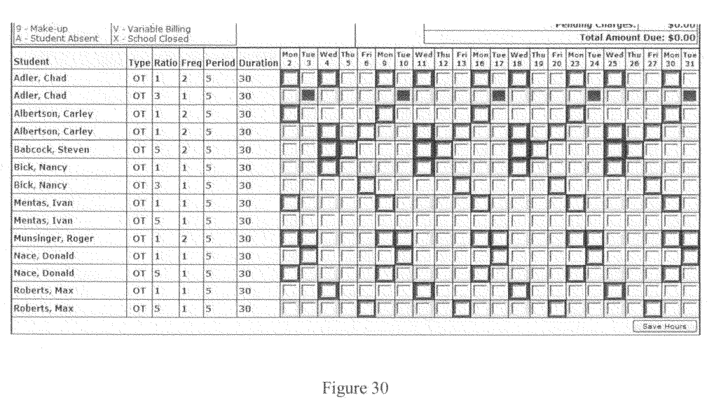

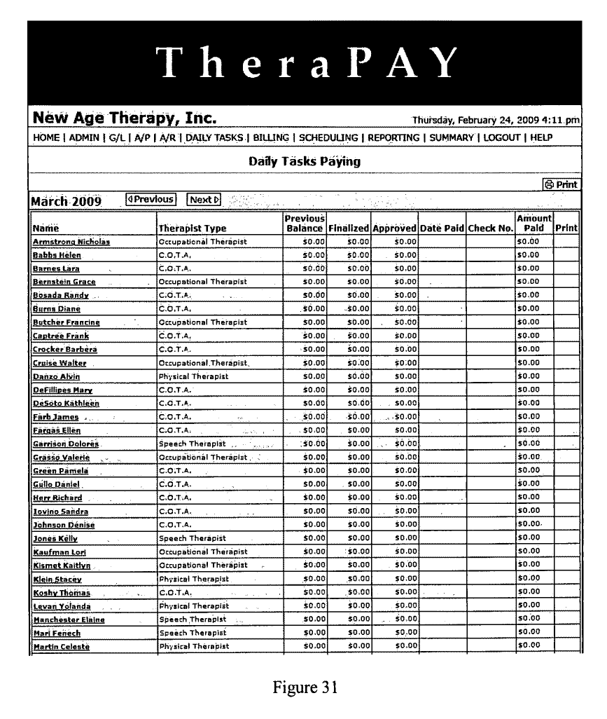

FIG. 13 shows a flow chart for the accounting system. The billing information regarding either accounts payable or accounts receivable is stored in the general ledger. If an invoice is issued to any of the accounts receivable customers, or a cash receipt is received from the customers, that information is stored general ledger reports and accounts receivable reports. Any purchases from vendors or services rendered by a therapist are also stored in the general ledger reports. An accounts payable aging report is generated whenever a expense is due. Upon approval by the agency, a check is administered to the vendor or therapist, this information is stored as a journal entry on the general ledger for auditing purposes by an accountant.

### Home

This button always brings the user back to the starting page after login.

### Admin

### Company Information:

This is a screen to enter all critical setup data into.

The Agency Name, Executive office, Administrative office, and Billing office should be entered, if they are the same address for all three, type in the same address for all three.

These fields are later used for reports, billing and system information.

### System Settings:

The System Settings section is used to set the variables used in the system:

Session Timeout—This sets the time frame required for the user to either type, or move the mouse before the system logs them out, for security reasons.

Allow Multiple Service Types Daily—This allows a student to be treated (and billed) by different types of therapist on the same school day.

Therapists Can Finalize if any Therapist Valid.—This allows for the system to continue the billing process by allowing therapist to finalize billing sheets, when their registration, license, or insurance information is not up to date (on this system).

Therapists Can Bill if Any Student Valid—This allows for the system to continue the billing process by allowing therapist to finalize billing sheets, when the student information is not completed. However the student's billing district, home district, and home school should be entered in order for billing to be completed.

Therapist Can View Previous Work Without Subscription—This allows therapist access for record keeping and review.

Last check Printed—allows the agency to start printing checks with a specific check number.

Default A/R Account—Is the default accounts receivable account invoices update in general ledger, once they are posted.

Default A/P Account—is the default account payable account purchases update when they are posted to the general ledger.

Default A/P Therapist Account—is the default accounts payable account billing sheets update once they finalized. This account can be the same as a purchases account, however most agencies will prefer to keep them separate.

Bad Debt Account—This is the account that gets updates when an invoice in part or in full is deemed uncollectible and it is written off.

Agreement—Is an agreement that can be customized to allow the Agency to have a “terms and conditions” use for their therapists and districts.

Accounting Rules—This is used to setup default accounts used in general ledger, when posting. Any posting to general ledger in a one way event. It cannot be revered, except through an adjusting journal entry.

Invoices—these are the default accounts used when posting invoices to G/L.

Cash Receipts—these are the default accounts used when posting invoices to G/L.

Purchases Check—these are the default accounts used when posting invoices to G/L. Single Check—these are the default accounts used when posting invoices to G/L.

Therapist Check—these are the default accounts used when posting invoices to G/L.

To save all changes—Click on the Save Changes button at the bottom, to Discard all changes click on the Cancel Button.

### Service Types

This allows a user to enter in a service type such as Occupational, Physical, or Speech Therapist. It also allows a user to pick a color so that they can quickly and easily know what type of therapist or therapy is scheduled at all times when using the system.

### Therapist Types

Is similar to service types, but allows you to assign a therapist to a specific treatment type, so that therapists that do speech are not accidentally assigned to a treatment they cannot perform.

### Billing Codes

This requirement is for setting up the agencies billing codes for all districts. If an agency charges the same fees for all districts and pays the same fees to all therapists, this is the only place you will have to enter this information. This includes individual sessions, group therapy, evaluations, meetings and any type of therapy or time the agency bills for. The billing code is the code used on the therapist billing sheets. It is a simple way of entering services that makes this whole system work.

### User Accounts

This allows the site administrator the ability to setup users of this system at the agency. This is not used to setup teachers, or therapists, or school officials. This is more meant for additional administrators of the system. Each user requires a unique username and password. A user should enter and email address here so that the administrator can get emails from this system, when another person needs to contact them.

### Counties

Identifies which counties a user services. This is used in reports and District setup.

### G/L—General Ledger

### Chart of Accounts

This is used to setup the chart of accounts, and should require the agency to get assistance from their accountant to be done properly. The user must enter the account number, description and what type of account it is.

### Journal Entries

Journal Entries are simply entries into the general ledger that get posted to reflect any adjustments made to accounting by an accountant. Again, this requires the assistance of an accountant. You must enter an entry date, reference number, accounts, descriptions and debits and credits. The total debits must equal the total credits at the bottom of this screen, or you will not be able to save the entry. Reversal entries occur when the box is checked.

### General Ledger Detail

This report prints all general ledger records in a detail format to show all debits and credit made to the accounting system. These include all postings, based on a selection of date and account range. These posting come from accounts payable, accounts receivable, journal entries, cash receipts and check processing.

### General Ledger Summary

This report is the same report as the detail report, but this report gives the user totals, without detail. So if there are 50 entries for a particular account, the user will only see the total for this account and not each individual entry. Again, this is subject to date and account ranges the user selects.

### Trial Balance

This report prints a trial balance from the general ledger details. It is critical in determining information an accountant needs to do the books.

### Financial Statement

This is a report for a selected time period, such as a month a quarter, or a year to reflect the agencies profitability. This will show all gross sales, cost of sales, gross profit and expenses. At the bottom of the report will be printed totals of net profit.

### A/P—Accounts Payable

### Vendors

Any purchases a user makes, or bills that are received from vendors should be entered here. This includes suppliers, rent, car bills, insurance and all other billing except therapists. All important information should be entered, including name, address, contact information and especially the default expense account for this vendor. When checks are printed, and the general ledger gets updated the expense will be allocated based on this code.

### Purchases

Purchases are all the bills you get from the landlord, utilities like electric and phone, as well as suppliers of services like accountants and lawyers and computer technicians. In order that a user may run an accounts payable aging report, and so that expenses can be tracked, you must enter them here. These entries are then chosen or selected to print the expense checks.

### Print Checks—Batch

This option allows a user to select those vendors the user wishes to pay based on due date, invoice date or vendor. This is for all the bills other than therapists, which are handled separately.

### Print Single Check

This is here to allow a user to print a one time manual check for someone that is not a vendor, and who has submitted a bill that needs to be paid right away and is not in purchasing. The only three fields required are name, expense account and amount.

### Print Therapists Checks

This option allows a user to pay therapists either individually or in a batch mode. A group of therapists can be selected, or a district or a single therapist can be paid. All billing sheets must be completed, and all invoices to the district must be finalized to pay the therapists. The user should pick the right account number if it is not the default account number that a user is paying the therapists from.

### A/R—Accounts Receivable

### Invoicing:

This is here so a user can invoice the school districts. Once the invoices have been printed, with invoice numbers on them and correct totals, they can be finalized. This process is preferably irreversible. This means that once an invoice has been finalized it can no longer be changed and is ready to be posted to the general ledger. After an invoice is finalized, if an adjustment must be made, it must be reflected on the next invoice.

### Cash Receipts

Cash receipts is the entry where payments by the district are entered. This allows for under payment, overpayment and exact payment. Once all the cash receipts have been entered the accounts receivable aging report will reflect this. After any cash receipts are entered and finalized they are ready for posting to general ledger. If an cash receipt is final and posted you cannot make any changes to the cash receipt, and it must be corrected the following month.

### Adjustments

Adjustments are made to invoices to reflect a problem in billing that cannot be adjusted in any other way or through billing sheets. These adjustments appear directly on the invoice as a subtotaled item. A user should make sure a clear reason is given for the adjustment, so the district will not reject the invoice. This reason prints directly on the district invoice.

### Post to G/L

This is a generic action that takes place for cash receipts, invoicing, check processing and journal entries. This basically says to the accounting system, that the transaction is now permanent and will always be and cannot be changed. It is the required action to get all entered, modified and adjusted transactions into the general ledger.

### Accounts Receivable Aging Report

This lists all invoices that are due the agency by district, by school, with columns and totals to reflect how old the invoices are and what are the total amounts owed the agency by district, by school, by age if invoice with totals for all. This report is a useful report used to collect receivables.

### Therapists

When a user clicks on this option, the user will see all the therapists entered into the system. Each time a therapist is added, all the following information should be entered: Name, Address, City, Zip, Phone Number, Residing County, Treating County, Therapist Type, TIN, License Number, Registration Number, and Expiration dates. It is very important to fill in expiration dates, so the computer can tell the user if someone's critical requirements to perform therapy have expired. The computer will not let therapist complete billing sheets if their information has expired if this option is turned on.

To the right side, next to insurance information is payment rates. This allows the user to override default payment rates in the system and allows the user to pay any rate the user negotiated for each individual.

After all the information is entered, the user must assign districts to the therapist and schools in order for them to be assigned to a particular student and a particular mandate. This is critical for this system to work.

### Districts

Districts are the highest level of customer information entered into the system. Without districts, schools cannot be entered, teachers cannot be entered, neither can students or mandates. Therefore this is required for the system to work correctly. All contact information is important. In order that the invoices come out correctly, the user must make sure the billing information is correct. If a user does not use the same rate for all districts, then the user must override the rates for THIS district. The rates for each code can be entered at the bottom left side of the form. At the right is billing ratio charges. This allows a user to break GROUPS down to charges for each student in groups of 2 or more. For example if a user charges 50.00 for one child but for two children you charge 60.00 the billing ratio for two students is 30.00. This way, when a therapist does a group session, they are billed correctly and the individual student is also tracked properly-from a billing standpoint. The user must click on the save changes button in the section where changes are made for the information to be saved and updated. The district should be given a unique user name and password if the district enters or sees information.

### Schools

Schools must belong to a district, and must all be entered if services are provided to students in the school. All the contact information must be entered here as well. Preferably, ALL the contact information is entered. A unique username and password can be assigned here if the user wants to let the school have access to this system. When the user has completed the whole form, click on teachers and fill in the teacher information. This is preferred when you are entering students into the program.

### Students

When entering students, the user must select the billing district, home district and the home school for the student. All information, including parental (or contact information) as well as date of birth should be entered. Date of birth is frequently used to determine billing for the right child (as when two children exist with the same name). Once the student is entered into the system, a user may go back anytime into the system and add a mandate or a job for the particular child. In the upper right hand side there is “Add Mandate” and “Create new Job”. If the user is setting up a referral, screening or evaluation the user cannot create a mandate for this. The user must create a job. If there is a mandate that is valid, then click on “add Mandate”. Either choice requires the user to assign and select a teacher and a therapist. Mandates drive this whole system and must be put in correctly. District information and therapist information should be included.

### Reports

Mandates This displays and prints all mandates.

P/L by Billing Codes—This report shows profit or loss by billing code with percentages.

P/L by Therapist This report shows profit or loss by billing code with percentages.

P/L by District This report shows profit or loss by district with percentages.

P/L by School This report shows profit or loss by school with percentages.

P/L by Therapist Type This report shows profit or loss by therapist type with percentages.

P/L by Service Type This report shows profit or loss by service type with percentages.

Payables for Therapists—This report shows how much money is owed therapists.

Receivables by School—This report shows you how much money each school owes.

Absence List—This report tells which kids were absent when.

### Preferred Embodiment

The present invention can be performed on a computing system which typically includes several functional components. These components may include a central processing unit (CPU), main memory, input/output (“I/O”) devices, and streaming storage devices. In conventional systems, the main memory is coupled to the CPU via a system bus or a local memory bus. The main memory is used to provide the CPU access to data and/or program information that is stored in main memory at execution time. Typically, the main memory is composed of random access memory (RAM) circuits.

The following is an example of the operation of the method of the present invention. In the following description, colors are referred to merely for clarity and the invention is not limited by any color reference.

1) HOME: Clicking here will bring you to the Message Board page.

a) TheraPAY Banner: Appears at the top of every screen and contains:
i) User's Name: Displays the name of the user who is logged on.
ii) Company Name: Displays the name of the company licensing the software.
iii) Date & Time: Displays the current date and time. This can not be changed.
iv) Special Alerts Message Bar: Displays scrolling messages in RED to the intended user(s). If no special alerts or messages are present the system will display a static GREY message reading No Special Alerts or Messages.

b) Message Board: Facilitates communication between agency staff, contract therapists, school district administrators, school personnel, teachers and parents or students themselves, if permitted by law. The Message board displays the message title, number of replies, original author and the date it was posted. PLEASE NOTE: Whenever a message is sent the system automatically inserts users name and the posting time which can be viewed by others.
i) Using the Message Board
   1. Create a Message: Click “New Message”
      (a) Message Title: The subject of your message
      (b) Message Type: Determines who can see message
         (i) Public: Viewable by all USERS <default>
         (ii) In-house: Viewable by all THERAPISTS
         (iii)Private: Viewable by all RECIPIENTS
      (c) Alert Type: Indicates if message is special alert
         (i) No: Message is not an alert <default>
         (ii) Yes: Message is an alert and appears in RED
      (d) Post Message to Message Board: Places Posting to the Message Board
         (i) Click “Post Message” to post the message and return to the Message Board after confirmation screen
         (ii) Click “Cancel” to delete the message and return directly to the Message Board
   2. Message Title: Used to describe the subject of your message
   3. Message Replies: Shows number of replies to the original message
   4. Viewing Replies: Click on the title of the message to view the replies
   5. Sending Replies: Bottom of Replies page shows “Post New Reply”
      2) ADMIN: Clicking here will bring you to the System Control page.

a) Company Information: Enter/Edit Specific Company Information.
i) Enter Company Name
ii) Enter Employer Tax ID Number.
iii) Executive Office: Address that appears on student reports
iv) Administration Office: Address that appears on therapist billing sheet.
v) Billing Office: Address that appears on district invoice and treatment log.
vi) System Settings: Used to set variables within in the system.
   1. Session Timeout: System automatically ends a session if user inactive.
   2. Last check Printed: Allows the agency to set last check number printed.
   3. Allow Multiple Service Types Daily: Controls multiple service types for the same mandate on the same day.
      (a) YES: Multiple service types can occur on the same day
      (b) NO: Multiple service types can NOT occur on the same day
   4. Therapists Can Finalize if any Therapist Valid=N: Controls therapist ability to submit a final billing sheet if any therapist documents expired.
      (a) YES: Allows Finalize; use if system not utilized for document control
      (b) NO: Disallows Finalize; use to prevent expired therapist documents
   5. Therapists Can Bill if Any Student Valid =N: Controls therapist ability to submit a final billing sheet if any student documents expired.
      (a) YES: Allows Finalize; use if system not utilized for document control
      (b) NO: Disallows Finalize; use to prevent expired student documents
   6. Therapist Can View Previous Work Without Subscription: Controls therapist's ability to preview past billing or notes without a subscription.
      (a) YES: Allows Previous work to be viewed
      (b) NO: Disallows Previous work to be viewed
   7. Digital Signature: Captures authorized signature for payroll checks.
   8. Default A/R Account: Account invoices update to G/L upon posting.
   9. Default A/P Account: Account purchases update to G/L upon posting.
   10. Default Expense Account: Account expenses update to G/L upon posting
   11. Default A/P Therapist Account: Account payroll update to G/L upon posting (posting occurs when therapists finalize billing sheets.
   12. Default Bad Debt Account: Account write-offs update to G/L posting.
   13. TheraPRO Agreement: Controls ability to use accounting features.
   14. TheraPAY Agreement: Controls ability to use billing features.
   15. TheraPLAN Agreement: Controls ability to use scheduling features.
   16. TheraPOST Agreement: Controls ability to use reporting features.
vii)Accounting Rules: Used to setup default general ledger accounts. Posting to the General Ledger can never be edited or deleted. Errors posted to the General Ledger are corrected by posting adjustments. See your Accountant.
   1. Invoices: Default accounts used when posting invoices to the G/L.
   2. Cash Receipts: Default accounts used when posting other income to G/L.
   3. Purchases Check: Default accounts used when posting purchases to G/L.
   4. Single Check: Default accounts used when posting payments to G/L.
   5. Therapist Check: Default accounts used when posting payroll to G/L.
viii) Save Changes Button: Click to save changes or CANCEL to discard changes.

b) Service Types: Add/Edit/View/Delete Service Types.
i) Title: License area abbreviation (ex. ST).
ii) Service Description: License area description (ex. Speech Therapy).
iii) Actions: Controls access to Service Types.
   1. Edit Service Types: Click Edit button in the Action Column.
   2. Delete Service Types: Click Delete button in the Action Column.
iv) Add Service Type: Click “Add Service Type”.
   1. Enter Service Type.
   2. Enter Service Description.
   3. Choose Service Type COLOR.
   4. Choose SORT Order to control the listing order of mandates in the system.

c) Therapist Types: Add/Edit/View/Delete Therapist Types.
i) License Area: Therapist License area description (ex. Speech Therapist).
ii) Service Type: Therapist License type (ex. ST).
iii) Therapy Assistant: Does the license type require professional supervision?
   1. YES: The system requires Supervisor approval of documentation.
   2. NO: The system does not require approval of documentation.
iv) Actions: Controls access to Therapist Types.
   1. Edit Therapist Types: Click Edit button in the Actions Column.
   2. Delete Therapist Types: Click Delete button in the Actions Column.
v) Add Therapist Type: Click “Add Therapist Type”.
   1. Enter License Area.
   2. Enter Service Type.
   3. Choose Assistant Y/N.
   4. Click “Add Therapist Type” to save changes or Cancel to discard changes.

d) Billing Codes: Add/Edit/View/Delete Billing Codes.
i) Code: Unique single character used to identify specific treatment sessions during billing and invoicing calculations, individual mandate compliance monitoring, therapist and student attendance record keeping, and treatment session documentation reporting requirements.
ii) Service Description: Ordinary description of unique computer billing codes.
iii) Cost Per Hour: System default amount paid to therapist for billing codes.
iv) Price Per Session: System default amount charged to school for billing codes.
v) Actions: Controls access to Billing Codes.
   1. Edit Billing Codes: Click Edit button in the Actions Column.
   2. Delete Billing Codes: Click Delete button in the Actions Column.
vi) Add Billing Codes: Click “Add Billing Code”.
   1. Enter Service Description.
   2. Enter Default Cost Per Hour.
   3. Enter Default Price Per Session.
   4. Choose Billing Code.
   5. Choose Billing Factor.
   6. Choose Display Order.
   7. Click “Add Billing Code” to save changes or Cancel to discard changes.

e) User Accounts: Add/Edit/View/Delete Administrator User Accounts.
i) Name: User's Last Name, First Name.
ii) Username: Name administrator enters at login.
iii) Email: Administrator's email address.
iv) Actions: Controls access to the user accounts.
   1. Edit User Account: Click Edit button in the Actions Column.
   2. Delete User Account: Click Delete button in the Actions Column.
v) Add User Account: Click “Add User Account”.
   1. Enter Username.
   2. Enter Password.
   3. Enter First Name.
   4. Enter Last Name.
   5. Enter Phone Number.
   6. Click “Create Account” to save changes or Cancel to discard changes.

f) Counties Serviced: Add/Edit/View/Delete Counties Serviced.
i) County: Name of the County Serviced.
ii) State: State where County is located.
iii) Actions: Controls access to the Counties.
   1. Edit Counties: Click Edit button in the Actions Column.
   2. Delete Counties: Click Delete button in the Actions Column.
iv) Add County: Click “Add County”.
   1. Enter County name.
   2. Choose State.
   3. Click “Add County” to save changes or Cancel to discard changes.

g) View My Invoices: View/Pay Software Licensing and Website Hosting Fees.
i) View Current Invoice.
   1. Click “Current Invoice” to view charges.
   2. Click “Pay” to arrange payment and follow instructions.
ii) View Next/Previous Invoices.
   1. Click “View Previous Invoice”.
   2. Click “View Next Invoice”.

### General Ledger

### Chart of Accounts

This is used to setup the Chart of Accounts and should require the agency to get assistance from their accountant to be done properly. The user must enter the account number, description and what type of account it is.

### Journal Entries

Journal Entries are simply entries into the General Ledger that get posted to reflect any adjustments made to accounting by an accountant. You must enter an entry date, reference number, accounts, descriptions and debits and credits. The total debits must equal the total credits at the bottom of this screen, or you will not be able to save the entry. Reversal entries occur when the box is checked.

### General Ledger Detail

This report prints all general ledger records in a detail format to show all debits and credit made to the accounting system. These include all postings, based on a selection of date and account range. These posting come from accounts payable, accounts receivable, journal entries, cash receipts and check processing.

### General Ledger Summary

This report is the same report as the detail report, but this report gives the user totals, without detail. So if there are 50 entries for a particular account, the user will only see the total for this account and not each individual entry. Again, this is subject to date and account ranges the user selects.

### Trial Balance

This report prints a trial balance from the general ledger details. It is critical in determining information an accountant needs to do the books.

### Financial Statement

This is a report for a selected time period, such as a month a quarter, or a year to reflect the agencies profitability. This will show all gross sales, cost of sales, gross profit and expenses. At the bottom of the report will be printed totals of net profit.

It is always recommended that a Certified Public Accountant (CPA) set up Accounts.

If Setup is not done correctly then Accounting System will NOT function as intended.

3) G/L General Ledger: Clicking here will bring you to the General Ledger page.

a) Chart of Accounts: Add/Edit/View/Delete Accounts.
i) Account Number: Number used to identify specific accounts.
ii) Description: Description of Account Number.
iii) Type: Choose the specific type of Account.
   1. Asset.
   2. Liability.
   3. Equity.
   4. Expense.
   5. Income.
   6. Accounts Receivable.
   7. Accounts Payable.
   8. Cost of Sales.
iv) Total Debits: Display the Total Amount of Debits for each Account.
v) Total Credits: Display the Total Amount of Credits for each Account.
vi) Actions: Controls access to Accounts.
   1. Edit Accounts: Click Edit button in the Actions Column.
   2. Delete Accounts: Click Delete button in the Actions Column.
vii) Add New Accounts: Click “Add New Account”.
   1. Enter Number.
   2. Enter Description.
   3. Click “Add County” to save changes or Cancel to discard changes.

b) Journal Entries: Add/Edit/View/Delete Journal Entries.
i) Entry: Number used to identify Journal Entry order.
ii) Date: Date the Journal Entry was entered.
iii) Reference: Reference Number for Journal Entry.
iv) Reverse: Identifies Reverse Entries
v) Credit Total: Display the Total Amount of Credits for each Journal Entry.
vi) Debit Total: Display the Total Amount of Debits for each Journal Entry.
vii) Actions: Controls access to Journal Entries.
   1. Edit Journal Entry: Click Edit button in the Actions Column.
   2. Delete Journal Entry: Click Delete button in the Actions Column.
viii) Add New Journal Entry: Click “Add New Journal Entry”.
   1. Enter Date:
   2. Enter Reference:
   3. Reverse Journal Entry
      (a) This is not a Reverse Entry. Select No <default>
      (b) This is a Reverse Entry. Select Yes
   4. Select Account: Select Account to Debit/Credit.
   5. Description: Enter Transaction Description.
   6. Amount: Enter Debit/Credit Amount.
   7. Click “Continue” to Save Record or “Cancel” to discard record and return to the Journal Entries page.
ix) Post Entries to G/L: Click “Post to G/L”.
   1. Select Entries with Checkmark or Click “Select All”.
   2. Click “Post Selected Entries” to Post to G/L or Click “Cancel”.
   3. Account: Select Account to Debit/Credit.
   4. Description: Enter Transaction Description.
   5. Amount: Enter Debit/Credit Amount.
   6. Click “Continue” to Save or “Cancel” to discard record.

c) General Ledger Detail: General Ledger Postings showing Debits and Credits.
i) Selecting Date Range: Enter Starting Date and Ending Date
   1. FROM: Enter Report Start Date
   2. TO: Enter Report End Date
ii) Selecting Account Range: Select Account(s) to search.
1. Accounts Payable.
   2. Accounts Receivable.
   3. Journal Entries.
   4. Cash Receipts.
   5. Check Processing.
iii) Click “Search” to display G/L Detail Records for the selected period.
   1. Date.
   2. Code.
   3. Account.
   4. Description.
   5. Invoice No.
   6. PO No.
   7. Check No.
   8. Debit.
   9. Credit.
   10. Entered By.

d) General Ledger Summary: General Ledger Accounts total Debits and Credits.
i) Selecting Date Range: Enter Starting Date and Ending Date
ii) Selecting Account Range: Select Account(s) to search.
   1. Accounts Payable.
   2. Accounts Receivable.
   3. Journal Entries.
   4. Cash Receipts.
   5. Check Processing.
iii) Click “Search” to display G/L Account Totals for the selected period.
   1. Date; Code; Account; Description; Debit; Credit; Entered By.

e) Trial Balance: Shows Trial Balance from General Ledger Details.
i) To Run a Trial Balance: Select Date Range. Click “Search”.

f) Financial Statement: Overall Profitability showing all Income and Expenses.
i) To Run a Financial Statement: Select Date Range. Click “Search”.

g) Balance Checkbook: Reconciles Bank Statements with General Ledger Accounts.

h) To Run a Bank Reconciliation Report

### Accounts Payable

### Vendors

Any purchases a company makes, or bills they receive from vendors should be entered here. This includes suppliers, rent, car bills, insurance and all other bills except therapist's salaries. All important information should be entered including: name, address, contact information and especially the default expense account for this vendor.

### Purchases

Purchases are all the bills you get from the landlord, utilities like electric and phone, as well as suppliers of services like accountants and lawyers and computer technicians. In order that a user may run an accounts payable aging report, and so that expenses can be tracked, you must enter them here. These entries are then chosen or selected to print the expense checks.

### Print Batch Checks

This option allows a user to select those vendors the user wishes to pay based on due date, invoice date or by vendor. This is for all bills except therapist's salary which is handled separately.

### Print Off-Cycle Check

This is here to allow a user to print a one-time manual check for someone that is not a vendor and has submitted a bill that needs to be paid off-cycle. Required fields are name, expense account and amount.

### Print Therapist's Checks

This is used to pay therapists either individually or in a batch mode. Therapists can be selected in groups or by district or a single therapist can be paid. All billing sheets must be completed and all invoices to the districts must be finalized in order to pay therapists.

4) A/P Accounts Payable: Clicking here will bring you to Accounts Payable.

a) Vendors: Add/Edit/View/Delete Vendors.
i) Vendor Number: Number used to identify each Vendor.
ii) Name: Name of the Vendor.
iii) Location: Address of the Vendor.
iv) Contact: Name of Contact Person at Vendor.
v) Phone: Phone Number of Vendor.
vi) Actions: Controls access to Vendors.
   1. Edit Vendors: Click Edit button in the Actions Column.
   2. Delete Vendors: Click Delete button in the Actions Column.
vii)Add New Vendors: Click “Add New Vendors”.
   1. Name: Enter Vendor Name.
   2. Contact Name: Enter Vendor Contact Person Name.
   3. Account: Select Account to Pay FROM.
   4. Address Line 1: Enter Vendor Address Line 1.
   5. Address Line 2: Enter Vendor Address Line 2.
   6. City: Enter Vendor City.
   7. State: Enter Vendor State.
   8. Zip: Enter Vendor Zip Code.
   9. Phone: Enter Vendor Phone Number.
   10. Fax: Enter Vendor Fax Number.
   11. Website: Enter Vendor URL.
   12. Email: Enter Vendors Email Address.
   13. Date Entered: Date Information Entered <default current date>
   14. Click “Add Vendor” to Save Record or “Cancel” to discard record.

b) Purchases: Add/Edit/View/Delete Purchases.
i) Date: Date of Purchase Order.
ii) Good Thru: Indicates Vendor Purchase Order Term.
iii) PO Number: Vendor Purchase Order Number.
iv) Invoice Number: Vendor Invoice Number.
v) Vendor: Name of Vendor.
vi) Total: Purchase Order Total Amount.
vii) Actions: Controls access to Purchase Orders.
   1. Edit Purchase Orders: Click Edit button in the Actions Column.
   2. Delete Purchase Orders: Click Delete button in the Actions Column.
viii) Add New Purchase Order: Click “Add New Purchase”.
   1. Choose Vendor. Click “Select”.
   2. Date: Enter New Purchase Order Date. <default current date>
   3. Good Thru: Enter New Purchase Order Good Thru Date.
   4. Customer Invoice Number: Enter Customer Invoice Number.
   5. Terms: Enter Terms of the New Purchase Order.
   6. Quantity: Enter Quantity from New Purchase Order.
   7. Description: Enter Description from New Purchase Order.
   8. Unit Price: Enter Unit Price from New Purchase Order.
   9. Amount: Enter Amount from New Purchase Order.
   10. Click “Continue . . . ” to Save Record or “Cancel” to discard record.

c) Print Batch Checks: Select Vendor Invoices to Pay.
i) Date: Date of Vendor Invoice.
ii) Good Thru: Vendor Payment Due Date.
iii) PO Number: Vendor Purchase Order Number.
iv) Invoice Number: Vendor Invoice Number.
v) Vendor: Name of Vendor.
vi) Total: Purchase Order Total Amount Due.
vii) Paid: Indicates Paid Status.
   1. Yes
   2. No
viii) Select Expense Account to Pay FROM
ix) Check Invoices to Pay or Click “Pay All Invoices”.
x) Click “Print Selected Checks” or “Cancel” to discard changes.

d) Print Single Check: Enter Non-Vendor Invoices to Pay.
i) Pay To The Order Of: Enter Check Payee <required>
ii) Amount: Enter Check Amount <required>
iii) Memo: Enter Payment Memo or Invoice Number.
iv) Address Line 1:
v) Address Line 2:
vi) Address Line 3:
vii) Address Line 4:
viii) Account to Debit: Expense Account Check Drawn <required>
ix) Click “Print Check” or “Cancel” to discard changes.

e) Print Therapist Checks:

f) Post Checks to G/L: Updates G/L with Checks and Cash Disbursements.
i) Date
ii) Code
iii) Description:
iv) Expense Account:
v) Invoice Number:
vi) Check Number:
vii) Amount:
viii) Checkmark Checks to Pay or Click “Select All”.
ix) Click “Post Selected Checks” or “Cancel” to discard changes.

g) Check Register: Lists All Checks Printed for the Month.

h) Name:

i) Therapist Type:

j) Date Printed:

k) Payment For:

l) Check No.

m) Amount Due:

n) Page Summary: Shows Total Amount Paid per Month.

### Accounts Receivable

### Invoicing:

This is used to invoice the school districts. Once the invoices have been mailed they can be finalized. This process is irreversible. This means that once an invoice has been finalized it can no longer be changed and is ready to be posted to the General Ledger. If an adjustment needs to be made after an invoice is finalized, it must be corrected and adjustment is reflected on the next invoice.

### Cash Receipts

Cash receipts are the entry where payments by the district are entered. This allows for under payment, overpayment and exact payment. Once all the cash receipts have been entered the Accounts Receivable Aging report will reflect them. After any cash receipts are entered and finalized they are ready for posting to general ledger.

### Adjustments

Adjustments are made to invoices to reflect a problem in billing that cannot be adjusted in any other way. These adjustments appear directly on the invoice as a subtotaled item. A user should make sure a clear reason is given for the adjustment that prints directly on the next district invoice.

### Post to G/L

This is a generic action that takes place for cash receipts, invoicing, check processing and journal entries. This basically says to the accounting system the transaction is now permanent and will always be and cannot be changed. This is the required action to get all entered, modified and adjusted transactions into the General Ledger.

### Accounts Receivable Aging Report

This lists all invoices that are due the agency by district, by school, with columns and totals to reflect how old the invoices are and what are the total amounts owed the agency by district, by school, by age if invoice with totals for all. This report is a useful report used to collect receivables.

5) A/R Accounts Receivable: Clicking here will bring to Accounts Receivable page.

a) Invoicing:
i) Date:
ii) District Name:
iii) Invoice Number:
iv) Amount:
v) Cost:
vi) Profit:
vii)Margin:
viii) Status:
ix) Print:

b) Cash Receipts:
i) Date:
ii) District Name:
iii) Invoice Number:
iv) Amount:
v) Balance:
vi) Amount Received:
vii) Date Received:
viii) Post to Account:
ix) Payment Type:
x) Save:

c) Adjustments:
i) District Name:
ii) County:
iii) Annual Budget:
iv) Select District to Adjust from Adjustments page:
v) Add Adjustment.
   (a) Description:
   (b) Amount:
   (c) Click “Add Adjustment” or “Cancel” to discard changes.
vi) Adjustments page shows adjustments.
vii) Click “Back to Invoice” to View Adjustment on Current Invoice.

d) Post to G/L: Post to General Ledger—Cash Receipts.
i) Date:
ii) Description:
iii) Post to Account:
iv) Invoice Number:
v) Amount:
vi) Type:
vii) Select:

e) Aging Report: Select Previous or Next to View Previous Months.

f) District Name:

g) Invoice Number:

h) 0-30 Days; 31-60 Days; 61-90 Days; Over 90 Days:

i) Amount Due:

### Therapists

When a user clicks on this option, the user will see all the therapists entered into the system. Each time a therapist is added, all the following information should be entered: Name, Address, City, Zip, Phone Number, Residing County, Treating County, Therapist Type, TIN, License Number, Registration Number, and Expiration dates. It is very important to fill in expiration dates, so the computer can tell the user if someone's critical requirements to perform therapy have expired. The computer will not let therapist complete billing sheets if their information has expired if this option is turned on. To the right side, next to insurance information are payment rates. This allows the user to override default payment rates in the system and allows the user to pay any rate the user negotiated for each individual. After all the information is entered, the user must assign districts to the therapist and schools in order for them to be assigned to a particular student and a particular mandate. This is critical for this system to work.

### 6) Billing: Click to go to Billing Homepage.

a) “Therapists” LINK: Click to go to Therapist Billing Homepage.

1. “Add New Therapist” LINK: Click to Add/Edit Therapist page.
(a) Therapist Name:
(b) Address Line 1:
(c) Address Line 2:
(d) City:
(e) State:
(f) Zip Code:
(g) Residing County:
(h) Treating County:
(i) Cell Phone:
(j) Home Phone:
(k) Fax Phone:
(l) Email:
(m)Therapist Type:
(n) TIN/SSN:
(o) License Number:
(p) License State:
(q) License Expires:
(r) Registration Number:
(s) Registration State:
(t) Registration Expires:
(u) Status:
(v) Username:
(w) Password:
(x) Show Date Bar:
(y) Therapist Signature:
(z) Therapist Fingerprint:
(aa) Therapist Picture:
(bb) Insurance Company Name:
(cc) Insurance Policy Number:
(dd) Insurance Policy Expires:
(ee) Insurance Limit per Occurrence:
(ff) Insurance Limit Aggregate:
(gg) Therapist Payment Rates per Billing Code:

2. “Locate Therapist” LINK: Click to go to Locate Therapist page.
(a) Select Date to Search and Click “Search”
   (i) Provider Name:
   (ii) District:
   (iii)School:
   (iv) Student:
   (v) Time Scheduled:
   (vi)Service Type:
(b) Select “Cancel” to return to Therapist Billing Homepage.

3. “Therapist Name” LINK: Click to go to Therapist Summary page.
(a) “Edit Information” LINK: Click to go to the Edit Therapist.
   (i) Make changes: See Add/Edit New Therapist.
   (ii) Click “Save Changes” or “Cancel”
(b) “Assigned Districts” LINK: Click to go to Assigned Districts.
   (i) “District Name” LINK: Click to go to District Summary.
      1. “School Name” LINK: Click to go to School Summary.
         a. “Teacher Name” LINK: Click to Teacher Summary.
         i. “Edit Information” LINK to go to Add/Edit Teacher
         ii. Teacher Information
         iii. Student Treatment Summary
         b. School:
         c. District:
         d. Total Students:
         e. Weekly Hours:
         f. Quarterly Hours:
         g. Annual Hours:
         h. Mandated Last Month:
         i. Billed Last Month:
         j. Mandate Coverage:
      2. Address:
      3. City:
      4. State:
      5. Zip:
      6. MAP to School:
      7. Telephone Number:
      8. Students:
      9. Mandates:
      10. Hours per Week:
      11. Remove:
      12. Assign New School:
      13. Select School Name.
      14. Click “Assign School” to Add School to Therapist.
   (ii) Assigned Schools: Schools assigned to therapist.
   (iii)Assigned Students: Students assigned to therapist.
   (iv)Assigned Mandates: Mandates assigned to therapist.
   (v) Hours per Week: Average hours assigned to therapist.
   (vi)Remove: Click to remove district from therapist.
(c) Therapist Summary
   (i) Status:
   (ii) License Valid:
   (iii)Registration Valid:
   (iv) Insurance Valid:
   (v) Total Students:
   (vi)Total Mandates:
   (vii) Hours per Week:
(d) Therapist Responsibilities
   (i) District:
   (ii) School:
   (iii)Student:
   (iv)Type:
   (v) Ratio:
   (vi) Frequency:
   (vii) Duration:
(e) Therapist Ranking: Billing/Scheduling/Reporting Ratio

4. License Type: The specific license a therapists holds (ex. O.T.A.)

5. Email: Link to contact therapist via email

6. Total Students: Total number of students assigned to therapist.

7. Weekly Hours: Average weekly hours therapist scheduled.

8. Quarterly Hours: Average quarterly hours therapist scheduled.

9. Yearly Hours: Average annual hours therapist is scheduled.

10. Assigned Mandates: Total assigned mandates to therapist.

11. Billed Last Month: Total number of mandates therapist serviced.

12. Mandate Coverage: Percentage of Mandates Serviced/Assigned.

13. “Billing Sheets” Link: Click to go to Current Billing Sheet.
(a) Student Names and Days of the Month intersect on Grid.
(b) Enter Billing Codes on Billing Grid when Treatment Sessions occur.
(c) Multiple Sessions are prevented for the same Service Type.
(d) Grey Box in Grid indicates School Closed. No billing permitted.
(e) Grey Box in Grid with ‘X’ indicates Missed Session/School Closed.
(f) Red Border in Grid indicates a Scheduled Session by the Therapist.
(g) Red Box in Grid indicates Scheduled Session by another Therapist.
(h) Green Border in Grid is Un-scheduled Session by the Therapist.
(i) Green Box in Grid is Un-scheduled Session by another Therapist.
(j) Blue Border in Grid when Daily Note option Inserts Billing Code.
(k) Click “Save Hours” to save work prior to a Session Timeout.
(l) Click “Finalize” to Submit Billing Sheet for Payment.
(m)Click “Approve” to Authorize Billing Sheet for Payment.

14. Column Totals with Mandate Coverage Percentage Average.

### Districts

Districts are the highest level of customer information entered into the system. Without districts, schools cannot be entered, teachers cannot be entered, and neither can students or mandates. Therefore this is required for the system to work correctly. All contact information is important. In order that the invoices come out correctly, the user must make sure the billing information is correct. If a user does not use the same rate for all districts, then the user must override the rates for THIS district. The rates for each code can be entered at the bottom left side of the form. At the right is billing ratio charges. This allows a user to break GROUPS down to charges for each student in groups of 2 or more. For example if a user charges 50.00 for one child but for two children you charge 60.00 the billing ratio for two students is 30.00. This way, when a therapist does a group session, they are billed correctly and the individual student is also tracked properly from a billing standpoint. The user must click on the save changes button in the section where changes are made for the information to be saved and updated. The district should be given a unique user name and password if the district enters or sees information.
b) “Districts” LINK: Click to go to District Billing Homepage.

1. “Add New District” LINK: Click to go to Add/Edit District page.
(a) District Name:
(b) Address Line 1:
(c) Address Line 2:
(d) City:
(e) State:
(f) Zip Code:
(g) County:
(h) Director SE:
(i) District Contact:
(j) Phone:
(k) Fax:
(l) Username:
(m)Password:
(n) Annual Budget:
(o) Signed Contract on File:
(p) Contract PDF:
(q) Fee Schedule on File:
(r) Fee PDF:
(s) District Calendar on File:
(t) Calendar PDF:
(u) Policies and Procedures on File:
(v) Policies PDF:
(w) Invoice Sorted By:
(x) Treatment Log Sorted By:
(y) Can View Billing Sheets:
(z) Can View Treatment Logs:
(aa) Can View Invoices:
(bb) Click “Add New District” or “Cancel” to discard changes.

2. “District Name” LINK: Click to go to District Summary page.
(a) “Edit Information” LINK: Click to go to the Edit District.
   (i) Make changes to District data: See Add/Edit New District.
   (ii) Click “Save Changes” or “Cancel” to discard changes.
(b) “District Name” LINK: Click to go to District Summary page.
   (i) “School Name” LINK: Click to go to School Summary.
      1. “School Name” LINK: Click to go to Teacher Summary page.
      2. Address:
      3. City:
      4. State:
      5. Zip:
      6. MAP to School:
      7. Telephone Number:
      8. Students:
      9. Mandates:
      10. Hours per Week:
      11. Remove:
      12. Assign New School:
      13. Select School Name
      14. Click “Assign School” to Add School to Therapist.
   (ii) Assigned Schools: Number of schools assigned to therapist
   (iii)Assigned Students: Number of students assigned
   (iv)Assigned Mandates: Number of mandates assigned
   (v) Hours per Week: Average number of hours assigned
   (vi)Remove: Click to remove district from therapist.

3. License Type: The specific license a therapists holds (ex. O.T.A.)

4. Email: Link to contact therapist via email

5. Total Students: Total number of students assigned to therapist.

6. Weekly Hours: Average weekly hours therapist scheduled to work.

7. Quarterly Hours: Average quarterly hours therapist scheduled.

8. Yearly Hours: Average annual hours therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Billing Sheets” Link: Click to go to Current Billing Sheet.

13. Totals appear at the bottom of each column for easy referencing.

14. Mandate Coverage Percentages Average presented across bottom.

### Schools

Schools must belong to a district, and must all be entered if services are provided to students in the school. All the contact information must be entered here as well. Preferably, ALL the contact information is entered. A unique username and password can be assigned here if the user wants to let the school have access to this system. When the user has completed the whole form, click on teachers and fill in the teacher information. This is preferred when you are entering students into the program.
c) “Schools” LINK: Click to go to School Billing Homepage.

1. “Add New School” LINK: Click to go to Add/Edit School page.
(a) School Name:
(b) Address Line 1:
(c) Address Line 2:
(d) City:
(e) State:
(f) Zip Code:
(g) School Contact:
(h) Phone:
(i) Fax:
(j) Username:
(k) Password:
(l) Click “Add New School” or “Cancel” to discard changes.

2. “School Name” LINK: Click to go to School Summary page.
(a) “Edit Information” LINK: Click to go to the Edit School.
   (i) Make changes to School data: See Add/Edit New School.
   (ii) Click “Save Changes” or “Cancel” to discard changes.
(b) “School Name” LINK: Click to go to School Summary page.
   (i) “School Name” LINK: Click to go to Assigned Teachers.
      1. “Teacher Name” LINK: Click to go to Teacher Summary.
      2. Address:
      3. City:
      4. State:
      5. Zip:
      6. MAP to School:
      7. Telephone Number:
      8. Students:
      9. Mandates:
      10. Hours per Week:
      11. Remove:
      12. Assign New School:
      13. Select School Name
      14. Click “Assign School” to Add School to Therapist.
   (ii) Assigned Students: Number of students assigned
   (iii)Assigned Mandates: Number of mandates assigned
   (iv)Hours per Week: Average number of hours assigned
   (v) Remove: Click to remove School from therapist.

3. License Type: The specific license a therapists holds (ex. O.T.A.)

4. Email: Link to contact therapist via email

5. Total Students: Total number of students assigned to therapist.

6. Weekly Hours: Average weekly hours therapist scheduled to work.

7. Quarterly Hours: Average quarterly hours therapist scheduled.

8. Yearly Hours: Average annual hours therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Billing Sheets” Link: Click to go to Current Billing Sheet.

13. Totals appear at the bottom of each column for easy referencing.

14. Mandate Coverage Percentages Average presented across bottom.
d) “Teachers” LINK: Click to go to Teacher Billing Homepage.

1. “Add New Teacher” LINK: Click to go to Add/Edit Teacher page.
(a) Teacher Name:
(b) Room Number:
(c) Phone:
(d) Username:
(e) Password:
(f) Click “Add New Teacher” or “Cancel” to discard changes.

2. “Teacher Name” LINK: Click to go to Teacher Summary page.
(a) “Edit Information” LINK: Click to go to the Edit Teacher.
(i) Make changes to Teacher data: See Add/Edit New Teacher.
   (ii) Click “Save Changes” or “Cancel” to discard changes.
(b) “Teacher Name” LINK: Click to go to Teacher Summary page.
   (i) “Student Name” LINK: Click to go to Assigned Mandates.
   (ii) Assigned Mandates: Number of mandates assigned
   (iii)Hours per Week: Average number of hours assigned
   (iv)Remove: Click to remove Teacher from therapist.

3. License Type: The specific license a therapists holds (ex. O.T.A.)

4. Email: Link to contact therapist via email

5. Total Students: Total number of students assigned to therapist.

6. Weekly Hours: Average weekly hours therapist scheduled to work.

7. Quarterly Hours: Average quarterly hours therapist scheduled.

8. Yearly Hours: Average annual hours therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Billing Sheets” Link: Click to go to Current Billing Sheet.

13. Totals appear at the bottom of each column for easy referencing.

14. Mandate Coverage Percentages Average presented across bottom.

### Students

When entering students, the user must select the billing district, home district and the home school for the student. All information, including parental (or contact information) as well as date of birth should be entered. Date of birth is frequently used to determine billing for the right child (as when two children exist with the same name). Once the student is entered into the system, a user may go back anytime into the system and add a mandate or a job for the particular child. In the upper right hand side there is “Add Mandate” and “Create new Job”. If the user is setting up a referral, screening or evaluation the user cannot create a mandate for this. The user must create a job. If there is a mandate that is valid, then click on “Add Mandate”. Either choice requires the user to assign and select a teacher and a therapist. Mandates drive this whole system and must be put in correctly. District information and therapist information should be included.
e) “Students” LINK: Click to go to Student Billing Homepage.

1. “Add New Student” LINK: Click to go to Add/Edit Student page.
(a) Student Name:
(b) Address Line 1:
(c) Address Line 2:
(d) City:
(e) State:
(f) Zip Code:
(g) County:
(h) Alerts:
(i) Student Contact:
(j) Phone:
(k) Username:
(l) Password:
(m)Click “Add New Student” or “Cancel” to discard changes.

2. “Student Name” LINK: Click to go to Student Summary page.
(a) “Edit Information” LINK: Click to go to the Edit Student.
   (i) Make changes to Student data: See Add/Edit New Student.
   (ii) Click “Save Changes” or “Cancel” to discard changes.
(b) “Student Name” LINK: Click to go to Student Summary page.
   (i) Assigned Mandates: Number of mandates assigned
   (ii) Hours per Week: Average number of hours assigned
   (iii)Remove: Click to remove Student from therapist.

3. License Type: The specific license a therapists holds (ex. O.T.A.)

4. Email: Link to contact therapist via email

5. Total Students: Total number of students assigned to therapist.

6. Weekly Hours: Average weekly hours therapist scheduled to work.

7. Quarterly Hours: Average quarterly hours therapist scheduled.

8. Yearly Hours: Average annual hours therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Billing Sheets” Link: Click to go to Current Billing Sheet.

13. Totals appear at the bottom of each column for easy referencing.

14. Mandate Coverage Percentages Average presented across bottom.

### Mandates

Mandates are at the lowest level on the data chain. Everything boils down to the mandate. Mandates are used to control billing activity, scheduling compliance, and reporting verification. Mandates determine which invoice the session billing appears on as well as ensuring students are treated according to their mandate. Mandates are responsible for determining how many reports a therapist will need to complete.
f) “Mandates”

i) Service District—District where treatment is received.

ii) Service School—School where treatment is received.

iii) Service Ratio—Number of Students in single session.

iv) Service Frequency—How many times during a week.

v) Service Period—Number of days in a period.

vi) Service Duration—How long treatment last in minutes.

vii) Service Location Onsite (student's school or other location).

viii) Extended year—treatment goes beyond normal school year.

ix) Finalized Mandate—Mandate has been approved and exists in IEP.

x) Service Goals on File—Goals are on file—filled in by therapist.

xi) Prescription on file—sent in by parents.

xii) Parental Consent on file—signed by parents.

xiii) Mandated Invoice—created automatically by the system.

xiv) Actual Invoice—created with Approved billing sheets.

xv) Scheduled Invoice—created with Finalized schedule.

### 7) Reports

a) Mandates: Displays and prints all mandates.

b) P/L by Billing Codes:—Displays profit and loss by billing code with percentages.

c) P/L by Therapist: Displays profit or loss by billing code with percentages.

d) P/L by District: Displays profit or loss by district with percentages.

e) P/L by School: Displays profit or loss by school with percentages.

f) P/L by Therapist Type: Displays profit or loss by therapist type with percentages.

g) P/L by Service Type: Displays profit or loss by service type with percentages.

h) Payables for Therapists: Displays how much money is owed therapists.

i) Receivables by School: Displays shows you how much money schools owe.

j) Absence List: Displays student and date of absence on a daily basis.

k) Available Make-up List: displays students and dates of absences after make-ups.

### Mandates:

Service District—District where treatment is received.

Service School—School where treatment is received.

Service Ratio—Number of Students in single session

Service Frequency—How many times during a wee

Service Period—Number of days in a period.

Service Duration—How long treatment last in minutes

Service Location Onsite (student's school or other location)

Extended year—treatment goes beyond normal school year.

Finalized Mandate—Mandate is no longer extended or it has been approved by the agency.

Service Goals on File—Goals are on file—filled in by therapist.

Prescription on file—sent in by parents.

Parental Consent on file—signed by parents.

Mandated Invoice—created automatically by the system.

Actual Invoice—created with Approved billing sheets.

Scheduled Invoice—created with Finalized schedule.

### 8) Scheduling: Click to go to Scheduling Homepage.

a) “Therapists” LINK: Click to go to Therapist Scheduling Homepage.

1. “Add New Therapist” LINK: Click to Add/Edit Therapist page.

2. “Locate Therapist” LINK: Click to go to Locate Therapist page.

3. “Therapist Name” LINK: Click to go to Therapist Summary page.
(a) “Assigned Districts” LINK: Click to go to Assigned Districts.
   (i) “District Name” LINK: Click to go to District Summary.
      1. “School Name” LINK: Click to go to School Summary.
         a. “Teacher Name” LINK: Click to Teacher Summary.
         i. “Edit Information” LINK to go to Add/Edit Teacher
         ii. Teacher Information
         iii. Student Treatment Summary
         b. School:
         c. District:
         d. Total Students:
         e. Weekly Sessions:
         f. Quarterly Sessions:
         g. Annual Sessions:
         h. Scheduled Last Month:
         i. Serviced Last Month:
         j. Schedule Coverage:
      2. Address:
      3. City:
      4. State:
      5. Zip:
      6. MAP to School:
      7. Telephone Number:
      8. Students:
      9. Mandates:
      10. Hours per Week:
      11. Remove:
      12. Assign New School:
      13. Select School Name.
      14. Click “Assign School” to Add School to Therapist.
   (ii) Assigned Schools: Schools assigned to therapist.
   (iii)Assigned Students: Students assigned to therapist.
   (iv)Assigned Mandates: Mandates assigned to therapist.
   (v) Hours per Week: Average hours assigned to therapist.
   (vi)Remove: Click to remove district from therapist.
(b) Therapist Summary
   (i) Status:
   (ii) License Valid:
   (iii)Registration Valid:
   (iv)Insurance Valid:
   (v) Total Students:
   (vi)Total Mandates:
   (vii) Sessions per Week:
(c) Therapist Responsibilities
   (i) District:
   (ii) School:
   (iii)Student:
   (iv)Type:
   (v) Ratio:
   (vi)Frequency:
   (vii) Duration:
(d) Therapist Ranking: Billing/Scheduling/Reporting Ratio

4. License Type: The specific license a therapists holds (ex. O.T.A.)

5. Email: Link to contact therapist via email

6. Total Students: Total number of students assigned to therapist.

7. Weekly Sessions: Average weekly sessions therapist scheduled.

8. Quarterly Sessions: Average quarterly Sessions therapist scheduled.

9. Yearly Sessions: Average annual Sessions therapist is scheduled.

10. Assigned Mandates: Total assigned mandates to therapist.

11. Billed Last Month: Total number of mandates therapist serviced.

12. Mandate Coverage: Percentage of Mandates Serviced/Assigned.

13. “Scheduling Sheets” Link: Click to go to Current Scheduling Sheet.
(a) Add Student to Schedule: Click “Add Student to Schedule”;
   (i) Choose District/School/Student/Mandate/Frequency
   (ii) Indicate Day and Time Session is scheduled.
   (iii)Click “Add to Schedule” or “Skip to Next Student”.

14. Column Totals with Mandate Coverage Percentage Average.
b) “Districts” LINK: Click to go to District Scheduling Homepage.

1. “Add New District” LINK: Click to go to Add/Edit District page.
(a) District Name:
(b) Address Line 1:
(c) Address Line 2:
(d) City:
(e) State:
(f) Zip Code:
(g) County:
(h) Director SE:
(i) District Contact:
(j) Phone:
(k) Fax:
(l) Username:
(m)Password:
(n) Annual Budget:
(o) Signed Contract on File:
(p) Contract PDF:
(q) Fee Schedule on File:
(r) Fee PDF:
(s) District Calendar on File:
(t) Calendar PDF:
(u) Policies and Procedures on File:
(v) Policies PDF:
(w) Invoice Sorted By:
(x) Treatment Log Sorted By:
(y) Can View Billing Sheets:
(z) Can View Treatment Logs:
(aa) Can View Invoices:
(bb) Click “Add New District” or “Cancel” to discard changes.

2. “District Name” LINK: Click to go to District Summary page.
(a) “Edit Information” LINK: Click to go to the Edit District.
   (i) Make changes to District data: See Add/Edit New District.
   (ii) Click “Save Changes” or “Cancel” to discard changes.
(b) “District Name” LINK: Click to go to District Summary page.
   (i) “School Name” LINK: Click to go to School Summary.
      1. “School Name” LINK: Click to go to Teacher Summary page.
      2. Address:
      3. City:
      4. State:
      5. Zip:
      6. MAP to School:
      7. Telephone Number:
      8. Students:
      9. Mandates:
      10. Sessions per Week:
      11. Remove:
      12. Assign New School:
      13. Select School Name
      14. Click “Assign School” to Add School to Therapist.
   (ii) Assigned Schools: Number of schools assigned to therapist
   (iii)Assigned Students: Number of students assigned
   (iv)Assigned Mandates: Number of mandates assigned
   (v) Sessions per Week: Average number of Sessions assigned
   (vi)Remove: Click to remove district from therapist.

3. License Type: The specific license a therapists holds (ex. O.T.A.)

4. Email: Link to contact therapist via email

5. Total Students: Total number of students assigned to therapist.

6. Weekly Sessions: Average weekly Sessions therapist scheduled to work.

7. Quarterly Sessions: Average quarterly Sessions therapist scheduled.

8. Yearly Sessions: Average annual Sessions therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Scheduling Sheets” Link: Click to go to Current Scheduling Sheet.

13. Totals appear at the bottom of each column for easy referencing.

14. Mandate Coverage Percentages Average presented across bottom.
c) “Schools” LINK: Click to go to School Scheduling Homepage.

1. “Add New School” LINK: Click to go to Add/Edit School page.
(a) School Name:
(b) Address Line 1:
(c) Address Line 2:
(d) City:
(e) State:
(f) Zip Code:
(g) School Contact:
(h) Phone:
(i) Fax:
(j) Username:
(k) Password:
(l) Click “Add New School” or “Cancel” to discard changes.

2. “School Name” LINK: Click to go to School Summary page.
(a) “Edit Information” LINK: Click to go to the Edit School.
   (i) Make changes to School data: See Add/Edit New School.
   (ii) Click “Save Changes” or “Cancel” to discard changes.
(b) “School Name” LINK: Click to go to School Summary page.
   (i) “School Name” LINK: Click to go to Assigned Teachers.
      1. “Teacher Name” LINK: Click to go to Teacher Summary.
      2. Address:
      3. City:
      4. State:
      5. Zip:
      6. MAP to School:
      7. Telephone Number:
      8. Students:
      9. Mandates:
      10. Sessions per Week:
      11. Remove:
      12. Assign New School:
      13. Select School Name
      14. Click “Assign School” to Add School to Therapist.
   (ii) Assigned Students: Number of students assigned
   (iii)Assigned Mandates: Number of mandates assigned
   (iv) Sessions per Week: Average number of Sessions assigned
   (v) Remove: Click to remove School from therapist.

3. License Type: The specific license a therapists holds (ex. O.T.A.)

4. Email: Link to contact therapist via email

5. Total Students: Total number of students assigned to therapist.

6. Weekly Sessions: Average weekly Sessions therapist scheduled to work.

7. Quarterly Sessions: Average quarterly Sessions therapist scheduled.

8. Yearly Sessions: Average annual Sessions therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Scheduling Sheets” Link: Click to go to Current Scheduling Sheet.

13. Totals appear at the bottom of each column for easy referencing.

14. Mandate Coverage Percentages Average presented across bottom.
d) “Teachers” LINK: Click to go to Teacher Scheduling Homepage.

1. “Add New Teacher” LINK: Click to go to Add/Edit Teacher page.
(a) Teacher Name:
(b) Room Number:
(c) Phone:
(d) Username:
(e) Password:
(f) Click “Add New Teacher” or “Cancel” to discard changes.

2. “Teacher Name” LINK: Click to go to Teacher Summary page.
(a) “Edit Information” LINK: Click to go to the Edit Teacher.
   (i) Make changes to Teacher data: See Add/Edit New Teacher.
   (ii) Click “Save Changes” or “Cancel” to discard changes.
(b) “Teacher Name” LINK: Click to go to Teacher Summary page.
   (i) “Student Name” LINK: Click to go to Assigned Mandates.
   (ii) Assigned Mandates: Number of mandates assigned
   (iii)Sessions per Week: Average number of Sessions assigned
   (iv)Remove: Click to remove Teacher from therapist.

3. License Type: The specific license a therapists holds (ex. O.T.A.)

4. Email: Link to contact therapist via email

5. Total Students: Total number of students assigned to therapist.

6. Weekly Sessions: Average weekly Sessions therapist scheduled to work.

7. Quarterly Sessions: Average quarterly Sessions therapist scheduled.

8. Yearly Sessions: Average annual Sessions therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Scheduling Sheets” Link: Click to go to Current Scheduling Sheet.

13. Totals appear at the bottom of each column for easy referencing.

14. Mandate Coverage Percentages Average presented across bottom.
e) “Students” LINK: Click to go to Student Scheduling Homepage.

1. “Add New Student” LINK: Click to go to Add/Edit Student page.
(a) Student Name:
(b) Address Line 1:
(c) Address Line 2:
(d) City:
(e) State:
(f) Zip Code:
(g) County:
(h) Alerts:
(i) Student Contact:
(j) Phone:
(k) Fax:
(l) Username:
(m)Password:
(n) Click “Add New Student” or “Cancel” to discard -changes.

2. “Student Name” LINK: Click to go to Student Summary page.
(a) “Edit Information” LINK: Click to go to the Edit Student.
   (i) Make changes to Student data: See Add/Edit New Student.
   (ii) Click “Save Changes” or “Cancel” to discard changes.
(b) “Student Name” LINK: Click to go to Student Summary page.
   (i) Assigned Mandates: Number of mandates assigned
   (ii) Sessions per Week: Average number of Sessions assigned
   (iii)Remove: Click to remove Student from therapist.

3. License Type: The specific license a therapists holds (ex. O.T.A.)

4. Email: Link to contact therapist via email

5. Total Students: Total number of students assigned to therapist.

6. Weekly Sessions: Average weekly Sessions therapist scheduled to work.

7. Quarterly Sessions: Average quarterly Sessions therapist scheduled.

8. Yearly Sessions: Average annual Sessions therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Scheduling Sheets” Link: Click to go to Current Scheduling Sheet.

13. Totals appear at the bottom of each column for easy referencing.

14. Mandate Coverage Percentages Average presented across bottom.

### 9) Reporting: Click to go to Reporting Homepage.

a) “Therapists” LINK: Click to go to Therapist Reporting Homepage.

1. “Add New Therapist” LINK: Click to Add/Edit Therapist page.
(a) Therapist Name:
(b) Address Line 1:
(c) Address Line 2:
(d) City:
(e) State:
(f) Zip Code:
(g) Residing County:
(h) Treating County:
(i) Cell Phone:
(j) Home Phone:
(k) Fax Phone:
(l) Email:
(m)Therapist Type:
(n) TIN/SSN:
(o) License Number:
(p) License State:
(q) License Expires:
(r) Registration Number:
(s) Registration State:
(t) Registration Expires:
(u) Status:
(v) Username:
(w)Password:
(x) Show Date Bar:
(y) Therapist Signature:
(z) Therapist Fingerprint:
(aa) Therapist Picture:
(bb) Insurance Company Name:
(cc) Insurance Policy Number:
(dd) Insurance Policy Expires:
(ee) Insurance Limit per Occurrence:
(ff) Insurance Limit Aggregate:
(gg) Therapist Payment Rates per Billing Code:

2. “Locate Therapist” LINK: Click to go to Locate Therapist page.
(a) Select Date to Search and Click “Search”
   (i) Provider Name:
   (ii) District:
   (iii)School:
   (iv) Student:
   (v) Time Scheduled:
   (vi) Service Type:
(b) Select “Cancel” to return to Therapist Reporting Homepage.

3. “Therapist Name” LINK: Click to go to Therapist Summary page.
(a) “Edit Information” LINK: Click to go to the Edit Therapist.
   (i) Make changes: See Add/Edit New Therapist.
   (ii) Click “Save Changes” or “Cancel”
(b) “Assigned Districts” LINK: Click to go to Assigned Districts.
   (i) “District Name” LINK: Click to go to District Summary.
      1. “School Name” LINK: Click to go to School Summary.
         a. “Teacher Name” LINK: Click to Teacher Summary.
         i. “Edit Information” LINK to go to Add/Edit Teacher
         ii. Teacher Information
         iii. Student Treatment Summary
         b. School:
         c. District:
         d. Total Students:
         e. Weekly Reports:
         f. Quarterly Reports:
         g. Annual Reports:
         h. Mandated Last Month:
         i. Billed Last Month:
         j. Mandate Coverage:
      2. Address:
      3. City:
      4. State:
      5. Zip:
      6. MAP to School:
      7. Telephone Number:
      8. Students:
      9. Mandates:
      10. Reports per Week:
      11. Remove:
      12. Assign New School:
      13. Select School Name.
      14. Click “Assign School” to Add School to Therapist.
   (ii) Assigned Schools: Schools assigned to therapist.
   (iii)Assigned Students: Students assigned to therapist.
   (iv)Assigned Mandates: Mandates assigned to therapist.
   (v) Reports per Week: Average Reports assigned to therapist.
   (vi)Remove: Click to remove district from therapist.
(c) Therapist Summary
   (i) Status:
   (ii) License Valid:
   (iii)Registration Valid:
   (iv) Insurance Valid:
   (v) Total Students:
   (vi) Total Mandates:
   (vii) Reports per Week:
(d) Therapist Responsibilities
   (i) District:
   (ii) School:
   (iii)Student:
   (iv)Type:
   (v) Ratio:
   (vi) Frequency:
   (vii) Duration:
(e) Therapist Ranking: Billing/Scheduling/Reporting Ratio

4. License Type: The specific license a therapists holds (ex. O.T.A.)

5. Email: Link to contact therapist via email

6. Total Students: Total number of students assigned to therapist.

7. Weekly Reports: Average weekly Reports therapist scheduled.

8. Quarterly Reports: Average quarterly Reports therapist scheduled.

9. Yearly Reports: Average annual Reports therapist is scheduled.

10. Assigned Mandates: Total assigned mandates to therapist.

11. Billed Last Month: Total number of mandates therapist serviced.

12. Mandate Coverage: Percentage of Mandates Serviced/Assigned.

13. “Reporting Sheets” Link: Click to go to Current Reporting Sheet.
(a) Choose Student and Report from Grid and Click VIEW
(b) Now To Add Report Click “Add Report”.

14. Column Totals with Mandate Coverage Percentage Average.
b) “Districts” LINK: Click to go to District Reporting Homepage.

1. “Add New District” LINK: Click to go to Add/Edit District page.
(a) District Name:
(b) Address Line 1:
(c) Address Line 2:
(d) City:
(e) State:
(f) Zip Code:
(g) County:
(h) Director SE:
(i) District Contact:
(j) Phone:
(k) Fax:
(l) Username:
(m)Password:
(n) Annual Budget:
(o) Signed Contract on File:
(p) Contract PDF:
(q) Fee Schedule on File:
(r) Fee PDF:
(s) District Calendar on File:
(t) Calendar PDF:
(u) Policies and Procedures on File:
(v) Policies PDF:
(w) Invoice Sorted By:
(x) Treatment Log Sorted By:
(y) Can View Billing Sheets:
(z) Can View Treatment Logs:
(aa) Can View Invoices:
(bb) Click “Add New District” or “Cancel” to discard changes.

2. “District Name” LINK: Click to go to District Summary page.
(a) “Edit Information” LINK: Click to go to the Edit District.
   (i) Make changes to District data: See Add/Edit New District.
   (ii) Click “Save Changes” or “Cancel” to discard changes.
(b) “District Name” LINK: Click to go to District Summary page.
   (i) “School Name” LINK: Click to go to School Summary.
      1. “School Name” LINK: Click to go to Teacher Summary page.
      2. Address:
      3. City:
      4. State:
      5. Zip:
      6. MAP to School:
      7. Telephone Number:
      8. Students:
      9. Mandates:
      10. Reports per Week:
      11. Remove:
      12. Assign New School:
      13. Select School Name
      14. Click “Assign School” to Add School to Therapist.
   (ii) Assigned Schools: Number of schools assigned to therapist
   (iii)Assigned Students: Number of students assigned
   (iv)Assigned Mandates: Number of mandates assigned
   (v) Reports per Week: Average number of Reports assigned
   (vi)Remove: Click to remove district from therapist.

3. License Type: The specific license a therapists holds (ex. O.T.A.)

4. Email: Link to contact therapist via email

5. Total Students: Total number of students assigned to therapist.

6. Weekly Reports: Average weekly Reports therapist scheduled to work.

7. Quarterly Reports: Average quarterly Reports therapist scheduled.

8. Yearly Reports: Average annual Reports therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Reporting Sheets” Link: Click to go to Current Reporting Sheet.

13. Totals appear at the bottom of each column for easy referencing.

14. Mandate Coverage Percentages Average presented across bottom.
c) “Schools” LINK: Click to go to School Reporting Homepage.

1. “Add New School” LINK: Click to go to Add/Edit School page.
(a) School Name:
(b) Address Line 1:
(c) Address Line 2:
(d) City:
(e) State:
(f) Zip Code:
(g) School Contact:
(h) Phone:
(i) Fax:
(j) Username:
(k) Password:
(l) Click “Add New School” or “Cancel” to discard changes.

2. “School Name” LINK: Click to go to School Summary page.
(a) “Edit Information” LINK: Click to go to the Edit School.
   (i) Make changes to School data: See Add/Edit New School.
   (ii) Click “Save Changes” or “Cancel” to discard changes.
(b) “School Name” LINK: Click to go to School Summary page.
   (i) “School Name” LINK: Click to go to Assigned Teachers.
      1. “Teacher Name” LINK: Click to go to Teacher Summary.
      2. Address:
   3. City:
      4. State:
      5. Zip:
      6. MAP to School:
      7. Telephone Number:
      8. Students:
      9. Mandates:
      10. Reports per Week:
      11. Remove:
      12. Assign New School:
      13. Select School Name
      14. Click “Assign School” to Add School to Therapist.
   (ii) Assigned Students: Number of students assigned
   (iii)Assigned Mandates: Number of mandates assigned
   (iv)Reports per Week: Average number of Reports assigned
   (v) Remove: Click to remove School from therapist.

3. License Type: The specific license a therapists holds (ex. O.T.A.)

4. Email: Link to contact therapist via email

5. Total Students: Total number of students assigned to therapist.

6. Weekly Reports: Average weekly Reports therapist scheduled to work.

7. Quarterly Reports: Average quarterly Reports therapist scheduled.

8. Yearly Reports: Average annual Reports therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Reporting Sheets” Link: Click to go to Current Reporting Sheet.

13. Totals appear at the bottom of each column for easy referencing.

14. Mandate Coverage Percentages Average presented across bottom.
d) “Teachers” LINK: Click to go to Teacher Reporting Homepage.

1. “Add New Teacher” LINK: Click to go to Add/Edit Teacher page.
(a) Teacher Name:
(b) Room Number:
(c) Phone:
(d) Username:
(e) Password:
(f) Click “Add New Teacher” or “Cancel” to discard changes.

2. “Teacher Name” LINK: Click to go to Teacher Summary page.
(a) “Edit Information” LINK: Click to go to the Edit Teacher.
   (i) Make changes to Teacher data: See Add/Edit New Teacher.
   (ii) Click “Save Changes” or “Cancel” to discard changes.
(b) “Teacher Name” LINK: Click to go to Teacher Summary page.
   (i) “Student Name” LINK: Click to go to Assigned Mandates.
   (ii) Assigned Mandates: Number of mandates assigned
   (iii)Reports per Week: Average number of Reports assigned
   (iv)Remove: Click to remove Teacher from therapist.

3. License Type: The specific license a therapists holds (ex. O.T.A.)

4. Email: Link to contact therapist via email

5. Total Students: Total number of students assigned to therapist.

6. Weekly Reports: Average weekly Reports therapist scheduled to work.

7. Quarterly Reports: Average quarterly Reports therapist scheduled.

8. Yearly Reports: Average annual Reports therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Reporting Sheets” Link: Click to go to Current Reporting Sheet.

13. Totals appear at the bottom of each column for easy referencing.

14. Mandate Coverage Percentages Average presented across bottom.
e) “Students” LINK: Click to go to Student Reporting Homepage.

1. “Add New Student” LINK: Click to go to Add/Edit Student page.
(a) Student Name:
(b) Address Line 1:
(c) Address Line 2:
(d) City:
(e) State:
(f) Zip Code:
(g) County:
(h) Alerts:
(i) Student Contact:
(j) Phone:
(k) Fax:
(l) Username:
(m)Password:
(n) Click “Add New Student” or “Cancel” to discard changes.

2. “Student Name” LINK: Click to go to Student Summary page.
(a) “Edit Information” LINK: Click to go to the Edit Student.
   (i) Make changes to Student data: See Add/Edit New Student.
   (ii) Click “Save Changes” or “Cancel” to discard changes.
(b) “Student Name” LINK: Click to go to Student Summary page.
   (i) Assigned Mandates: Number of mandates assigned
   (ii) Reports per Week: Average number of Reports assigned
   (iii)Remove: Click to remove Student from therapist.

3. License Type: The specific license a therapists holds (ex. O.T.A.)

4. Email: Link to contact therapist via email

5. Total Students: Total number of students assigned to therapist.

6. Weekly Reports: Average weekly Reports therapist scheduled to work.

7. Quarterly Reports: Average quarterly Reports therapist scheduled.

8. Yearly Reports: Average annual Reports therapist is scheduled to work.

9. Assigned Mandates: Total number of assigned mandates.

10. Billed Last Month: Total number of mandates therapist serviced.

11. Mandate Coverage: Percentage of Mandates Serviced/Assigned.

12. “Reporting Sheets” Link: Click to go to Current Reporting Sheet.

13. Totals appear at the bottom of each column for easy referencing.

14. Mandate Coverage Percentages Average presented across bottom.

10) “Daily Tasks” LINK: Click here to go to Daily Tasks Homepage.
a) Mandates—New Mandates are entered here, as well as existing mandates, which can be edited here.
b) Billing sheets—Therapists must enter their billing time sheets using this option. A given therapist can only see billing sheets assigned to them, while the agency can see all billing sheets.
c) Invoices—This option must be used to invoice a school district, which can only be done by the agency, not a therapist.
d) Cash Receipts—This allows you to enter any payments made by the district to keep track of what is owed.
e) Print checks—This allows you to print checks to Therapists for work performed.
   11. “Reports” LINK: Click here to go to Reports Homepage

f) Assigned mandates: Provides a list of assigned mandates.

g) Unassigned mandates: Displays and prints a list of unassigned mandates.

h) Billed Mandates: Provides a list of billed mandates.

i) Unbilled Mandate: Provides a list of unbilled mandates.

j) Profit and Loss:
i) P/L by Billing Codes: Shows profit/loss by billing code with percentages.
ii) P/L by Therapist: Shows profit/loss by billing code with percentages.
iii) P/L by District: Shows profit/loss by district with percentages.
iv) P/L by School: Shows profit/loss by school with percentages.
v) P/L by Therapist Type: Shows profit/loss by therapist type with percentages.
vi) P/L by Service Type: Shows profit or loss by service type with percentages.
vii) Payables—Shows how much money you owe therapists.

k) Print 1099: This option prints the 1099 forms for each therapist.

l) Receivables: This report shows you how much money each school owes you.

m) Makeup List: This report lists any absences that need to be made up.

n) User Logs: This option shows each user of the system with date and time.

Other reports can be generated as desired including but not limited student reports concerning the treatment.

### Glossary of Terms:

### General Terms

Session Timeout: Time frame before the system logs user out for security reasons.

Allow Multiple Service Types Daily: This allows different services on the same day.

Therapists Can Finalize if Therapist Valid: Registration, License, or Insurance expired

Therapists Can Bill if Any Student Valid: Therapist can finalize if student info expired

Therapist Can View Previous Work Without Subscription: This allows therapist access.

Last check Printed: Start printing checks with a specific check number.

Default AIR Account: Default account invoices update to in general ledger after posting.

Default A/P Account: Default account checks update to in general ledger after posting.

Default A/P Therapist: Default account billing sheets update to in general ledger.

Bad Debt Account: Updates when invoice is deemed uncollectible and it is written off.

Accounting Rules: Posting to the General Ledger is a one way event.

Invoices: Default accounts used when posting invoices to General Ledger.

Cash Receipts: Default account used when payments to General Ledger.

Purchases Check: Default account used when posting purchases to General Ledger.

Single Check: Default account used when posting irregular payments to General Ledger.

Therapist Check: Default account used when posting payroll to General Ledger.

Service Types: A service type is the type of therapy.

License Types: A license type is the type of therapist.

Billing Codes: Any type of therapy or time the agency bills for.

User Accounts: This allows the site administrator to setup other administrators

Counties: Identifies which counties a user services.

I claim:

1. An automated method for providing therapy for a student comprising:
identifying a student who requires therapy,
determining therapy treatment that satisfies the student's therapy needs,
issuing the therapy treatment determination to a government agency,
receiving a student mandate from said government agency,
using a system having a processor and a memory component, said memory component storing student information and therapist information,
analyzing the student's information and therapist information to assign one or more therapists to a student for each session based on the student's needs as detailed in the student's mandate,
generating a schedule based on said analysis for the student and therapists,
recording treatment data provided by said therapist to said student
billing the school district for the mandate,
compensating the therapist for each session where the therapist provided services.

2. The method according to claim 1 wherein said system provides an interface to enter information about said schools, students, and therapists and stores said information in said memory component.

3. The method according to claim 2 wherein said system provides an interface for an agency to assign therapists to a student and schedule meeting times for each session, said application displays said assignments online as a student schedule.

4. The method according to claim 3 wherein said system processor component prevents over-scheduling of therapists per student mandate.

5. The method according to claim 4 wherein said system processor component prevents a student or therapist from being scheduled for two different sessions at the same time.

6. The method according to claim 5 wherein said system processor component, having a means for recommending schedules for students and therapists, provides a list of schedules to said agency for approval.

7. The method according to claim 6 wherein said system processor component, having a means to generate and distribute a notification, notifies said therapists about upcoming appointments.

8. The method according to claim 7 wherein said system processor component, having a means to generate and distribute a notification, notifies said students about upcoming appointments.

9. The method according to claim 8 wherein said system processor component generates accounting reports.

10. The method according to claim 9 wherein said system processor component generates checks for the vendors.

11. The method according to claim 10 wherein said system processor component provides an interface to enter information from said therapist about each session.

12. The method according to claim 1 wherein said government agency is a school district.

13. The method according to claim 1 wherein the therapist is a physical therapist.

14. The method according to claim 1 wherein the therapist is a occupational therapist.

15. The method according to claim 1 wherein the therapist is a speech therapist.

16. The method according to claim 1 further comprising the step of updating the student information based on treatment received by the student.

17. An automated method for providing therapy for a student comprising:
receiving a student mandate from said government agency,
using a system having a processor and a memory component, said memory component storing student information and therapist information
analyzing the student's information and therapist information to assign therapists to a student for each session based on the student's needs as detailed in the student's mandate,
creating a schedule based on said analysis for the student and therapists,
billing the school district for the mandate,
compensating the therapist for each session the therapist provided services.

18. The method according to claim 17 wherein said system provides an interface to enter information about said schools, students, and therapists and stores said information in said memory component.

19. The method according to claim 18 wherein said system provides an interface for an agency to assign therapists to a student and schedule meeting times for each session, said application displays said assignments online as a student schedule.

20. The method according to claim 19 wherein said system processor component prevents over-scheduling of therapists per student mandate.

21. The method according to claim 20 wherein said system processor component prevents a student or therapist from being scheduled for two different sessions at the same time.

22. The method according to claim 21 wherein said system processor component, having a means for recommending schedules for students and therapists, provides a list of schedules to said agency for approval.

23. The method according to claim 22 wherein said system processor component, having a means to generate and distribute a notification, notifies said therapists about upcoming appointments.

24. The method according to claim 23 wherein said system processor component, having a means to generate and distribute a notification, notifies said students about upcoming appointments.

25. The method according to claim 24 wherein said system processor component generates accounting reports.

26. The method according to claim 25 wherein said system processor component generates checks for the vendors.

27. The method according to claim 26 wherein said system processor component provides an interface to enter information from said therapist about each session.

28. The method according to claim 17 wherein said government agency is a school district.

29. The method according to claim 17 wherein the therapist is a physical therapist.

30. The method according to claim 17 wherein the therapist is a occupational therapist.

31. The method according to claim 17 wherein the therapist is a speech therapist.

32. The method according to claim 17 further comprising the step of updating the student information based on treatment received by the student.

33. An automated system for providing therapy for a student comprising:
an interface component, wherein said interface component receives student and therapist information from a user,
a memory component, wherein said memory component stores student information, therapist information and session information,
a processor component, wherein said processor component retrieves said student and therapist information from said memory component, analyzes said student and therapist information, checks schedule requests from said user for appointment conflicts or student over-scheduling, and generates a schedule based on said analysis of student and therapist information and schedule requests.

34. An automated system according to claim 33 wherein said system, using information provided by said user, generates a recommended student and teacher schedule based on the student's needs as detailed in the student's mandate.

35. An automated system according to claim 34 wherein said interface component receives assignment information from said user.

36. An automated system according to claim 35 wherein said interface component displays therapist schedules, student schedules and accounting reports.

37. The method according to claim 1 where the therapist generates a report concerning the student's treatment and provides the report to an agency.

38. The method according to claim 37 wherein said agency provides the report to a school district.

39. The method according to claim 1 wherein the records of said student are maintained for as long as the law requires.
